(19) United States
(12) Patent Application Publication
(10) Pub. No.: US 2014/0152163 A1
(43) Pub. Date: Jun. 5, 2014

(54) BAG HOLDER FOR HOLDING CAT LITTER BAGS AND METHOD OF MANUFACTURING THE BAG HOLDER

(71) Applicant: Robert Sweetman, Staten Island, NY (US)

(72) Inventor: Robert Sweetman, Staten Island, NY (US)

(21) Appl. No.: 13/690,188

(22) Filed: Nov. 30, 2012

(51) Int. Cl. A47B 81/00; B23P 11/00

(52) U.S. Cl. CPC A47B 81/00; B23P 11/00
USPC 312/330.1; 29/428

(57) ABSTRACT

A bag holder is disclosed for holding cat litter bags for containing cat litter waste from a cat litter box, along with a method of manufacturing the bag holder. The bag holder includes a housing coupled to a support structure, such as a side panel of the litter box, or a wall near the cat litter box. An attachment arrangement connects the housing to the support structure. Alternatively, the housing may be integrally formed with the litter box. A drawer is slidably disposed within the housing, and defines a storage space for stowing the litter bags. The drawer can be rigid and outwardly movable from the housing. Alternatively, the drawer can have walls that are fluted for expanding the drawer in an accordion-like fashion outwardly from the housing. Location and configuration of the bag holder encourages the user to use the litter bags for sanitary disposal of cat litter waste.

### FIELD OF THE INVENTION

This invention generally relates to bag holders, and more specifically to bag holders for holding cat litter bags.

### BACKGROUND OF THE INVENTION

Cat litter boxes are used by cats for deposit of cat biological waste that includes urine and fecal matter. Contained in the litter box is cat litter that absorbs the cat's waste. The waste, after being absorbed by the cat litter, forms compact clumps over time, and the clumps are typically sifted from the litter box by a user, such as the cat's owner, using a litter scoop with walls that act like a sieve or strainer. The walls allow unclumped litter material to pass through the sieve while simultaneously retaining the waste clumps on the litter scoop. The waste clumps are typically placed in a disposal bag that is subsequently discarded. Clumping cat litter is typically a chemical composition comprising diatomaceous earth that is 80% to 90% silica (SiO₂) with the remaining constituents being alumina (AlO₃) and iron oxide (Fe₂O₃). Granular size of the cat litter is usually about 0.5 millimeters (0.0197 inch) to about 2 millimeters (0.0787 inch) and density is typically about 0.9 grams per cubic centimeter (56.19 pounds per cubic foot) to about 0.95 grams per cubic centimeter (59.31 pounds per cubic foot). This chemical composition and density for the cat litter allows the cat litter to be absorbent and facilitates formation of the compact clumps for easier collection and disposal.

However, the cat's waste contained in the litter clumps scooped from the litter box may contain organisms harmful to human health, such as escherichia coli bacteria and texoplasma gondii protozoa. For example, in the case of cat fecal matter, the harmful organisms may include texoplasma gondii, which is a parasite acquired by the cat eating infected rodents, birds or other small animals. Texoplasma gondii can survive in soil for more that a year and can also contaminate drinking water. However, most municipal water treatment systems are not designed to filter texoplasma gondii. Therefore, drinking water may be at risk of being contaminated with texoplasma gondii, unless precautions are taken to prevent contamination, such as disposal of the cat's waste in a manner avoiding contact with drinking water.

More specifically, it is important that cat waste not enter the biosphere. For example, the previously mentioned texoplasma gondii poses a health risk to humans, especially those having compromised immune systems caused by disease, such as Acquired Immune Deficiency Syndrome (AIDS). As another example of potential health risk, texoplasma gondii contamination has been found in blood used for blood transfusions and organs donated for transplantation, as well as in other medical treatment environments. In addition, Toxoplasmosis, which is caused by the texoplasma gondii parasite, has been linked to birth defects, blindness and brain damage in children born to infected mothers. Therefore, as a precaution, some state environmental agencies require cat litter packages to bear a warning label instructing cat owners not to flush used cat litter or otherwise dispose of used cat litter in storm drains. For example, in the state of California, U.S.A., cat litter sold in the state must carry a warning label stating the dangers of toxoplasmosis to humans, and cat owners caught flushing used cat litter are subject to fines of up to $25,000. To protect the environment and to comply with state law, used cat litter is preferably placed in disposal bags and put in household trash that is subsequently collected and deposited in a landfill. Consequently, it is important that used cat litter be discarded in an environmentally safe, sanitary and lawful manner.

As previously mentioned, cat litter waste clumps scooped from the cat litter box are preferably placed in a disposal bag that is subsequently discarded in a landfill. However, keeping track of the location of the disposal bags and organizing the disposal bags for ready access when needed is inconvenient for the user. This inconvenience discourages the user from removing the waste clumps from the cat litter box on a regular and frequent basis. This inconvenience also discourages the user from using disposal bags rather than simply flushing the cat litter waste clumps. Delayed removal of the waste clumps from the cat litter box allows the waste clumps to accumulate in the cat litter box. However, allowing the waste clumps to accumulate in the cat litter box poses a health risk to the user. This is so because the user may inadvertently inhale fine particles of contaminated litter dust emanating from the contaminated litter in the cat litter box or otherwise inadvertently come into contact with the contaminated litter in the cat litter box. Moreover, as previously mentioned, simply flushing the cat litter waste clumps to avoid the inconvenience of locating and using cat litter bags when needed increases the risk of contaminating municipal water systems and violates some state laws.

Attempts have been made to address the considerations mentioned hereinabove with respect to storage and use of cat litter bags for disposal of cat litter waste. For example, U.S. Pat. No. 5,181,480 titled “Litter-Box And Litter Dispensing Hopper” issued Jan. 26, 1993, in the name of Sheila Dabolt relates to a combination including a litter box and dispensing hopper for the litter.

According to the Dabolt patent, a litter box includes four side walls. The side walls have an opening to allow insertion and removal of a wire-frame bag holder adapted to receive a refuse bag and hold it in an open position. A floor of the litter box includes floor sections having upper surfaces that are automatically cleaned of soiled litter by a scraping action of scrapers which remove the soiled litter from the floor sections and direct it into the bag. The holder can then be removed to allow removal of the bag with soiled litter and to allow insertion of a new bag.

However, the Dabolt device does not appear designed to accommodate storage of multiple litter bags in the device. Rather, it appears one litter bag at a time is stored and accommodated in the device. Therefore, it appears that a user of the Dabolt device must locate a fresh litter bag externally of the device for insertion into the device each time a fresh litter bag is needed. Keeping track of litter bags located somewhere externally of the device is an inconvenience for the user. For this reason, the user may be discouraged from emptying soiled litter from the litter box on a regular and frequent basis. As previously mentioned, unnecessary delay in emptying the cat litter box of soiled litter poses a health risk to the user and others. In addition, due to this inconvenience, the user may be motivated to simply flush the soiled cat litter and thereby risk contamination of municipal water supplies and violation of state law.

Another attempt to address the considerations mentioned hereinabove with respect to storage and use of cat litter bags for disposal of cat litter waste is disclosed in U.S. Pat. No. 5,855,186 titled “Sanitation System For Cat Litter Boxes” issued Jan. 5, 1999, in the name of Knut H. Larsen. This patent relates to a sanitization system for cat litter boxes which provides for the removal of cat fecal matter, continuous deodorization, and ready-waste disposal.

More specifically, the Larsen disclosure is directed to a sanitation system for cat litter boxes where the system disinfects a litter scoop, provides deodorization of the litter box environment and supplies disposal bags for ready containment of the cat fecal matter which is thereafter deposited in a waste removal or garbage removal system of a household. In this regard, the system includes a bag holder which has a frame. The frame is removably mounted to the cat litter box for holding plastic bags into which the cat fecal matter is deposited. To provide for sanitization of the litter box scoop, a removably mounted litter box disinfection fluid reservoir is utilized into which the litter box scoop is placed. This patent states that, in one embodiment, a first storage region is carried by a sidewall of the fluid reservoir and a second storage region is also carried by the sidewall of the fluid reservoir. The first storage region is so dimensioned and proportioned to permit the storage of plastic bags and the second storage region is so dimensioned and proportioned to permit the storage of ties for the plastic bags. However, this patent does not present drawings or express description disclosing the specific structure of the first storage region and second storage region. In this regard, the description that is provided appears to indicate that the first storage region, the second storage region and the reservoir are separate components, the first and second storage regions being carried by the side walls of the fluid reservoir. In other words, the Larsen device appears to require at least three separate components, the three separate components being the first storage region, the second storage region, and the fluid reservoir. This apparent level of structural complexity may discourage some users from utilizing the fluid reservoir, the storage bags located in the first storage region and the ties located in the second storage region. This may be so because handling three separate components, rather than only one or two components, may be too inconvenient for some users.

### SUMMARY OF THE INVENTION

One general aspect of the invention is a bag holder for holding a plurality of cat litter bags adapted to contain cat litter waste from a cat litter box. The bag holder includes: a housing adapted to be coupled to a support structure, the housing defining a cavity therein, and defining an opening in communication with the cavity; and a drawer adapted to be disposed in the cavity, the drawer being slidable partially through the opening, the drawer defining a storage space therein for storing the plurality of cat litter bags.

In some embodiments, the bag holder includes an attachment arrangement adapted to couple the housing to the support structure. In further embodiments, the attachment arrangement includes a brace and/or a screw fastener. In other further embodiments, the attachment arrangement includes at least one of: an adhesive layer and adhesive tape. In other further embodiments, the attachment arrangement includes hook-and-loop fastener material. In other further embodiments, the attachment arrangement includes: a mounting bracket; and at least one stud attached to the mounting bracket, and wherein housing defines at least one slot therein sized to slidably engage the at least one stud for slidably coupling the housing to the mounting bracket. In other further embodiments, the attachment arrangement includes: a mounting plate; and a bag closure dispenser coupled to the mounting plate for dispensing a bag closure therefrom.

In some embodiments, the support structure is a side panel of the cat litter box, and wherein the housing is integrally formed with the side panel so as to define a cavity having an opening.

In some embodiments, the drawer includes: a bag support disposed in the storage space and adapted to support cat litter bags; and a biasing member coupled to the bag support for biasing the bag support.

In some embodiments, drawer includes opposing side walls, each side wall defining a plurality of expandable flutes therein for expandably moving the drawer through the opening.

In some embodiments, the drawer includes: a pivot pin connected to the housing; and opposing side walls rotatably mounted on the pivot pin, the side walls defining a plurality of expandable and bendable flutes therein for expanding and bending the drawer about the pivot pin in a downward arc through the opening.

In some embodiments, at least one of the drawer and the housing includes a pathogen resistant, anti-microbial, antifungal composition for decreasing health risk to humans.

In some embodiments, the drawer includes a pivotable top wall coupled to the housing.

Another general aspect of the invention is a bag holder for holding cat litter bags adapted to contain cat litter waste from a cat litter box, such that the bag holder includes: a housing that is integrally formed with a side panel of the cat litter box so as to define a cavity having an opening; and a drawer disposed within the cavity, and slidable partially through the opening, the drawer defining a storage space therein for storing the cat litter bags.

In some embodiments, the drawer includes: an upright bag support slidably disposed within the storage space, and adapted to support and compress the cat litter bags; and a spring attached to the bag support for biasing the bag support, whereby the cat litter bags are supported and compressed in the storage space as the bag support is biased.

In some embodiments, the drawer includes opposing side walls, each side wall defining a plurality of expandable flutes therein for expandably moving the drawer through the opening.

In some embodiments, the drawer includes: a pivot pin connected to the housing; and opposing side walls rotatably mounted on the pivot pin, the side walls defining a plurality of expandable and bendable flutes therein for expanding and bending the drawer about the pivot pin in a downward arc through the opening.

In some embodiments, at least one of the drawer and the housing includes a pathogen resistant, anti-microbial, antifungal composition for decreasing health risk to humans.

In some embodiments, the drawer comprises a top wall adapted to pivot about a pivot pin coupled to the housing.

Another general aspect of the invention is a method of manufacturing a bag holder for holding cat litter bags adapted to contain cat litter waste retrieved from a cat litter box. The method includes providing a housing adapted to be coupled to a support structure, the housing defining a cavity therein and an opening in communication with the cavity; and disposing a drawer in the cavity, the drawer being slidable partially through the opening, the drawer defining a storage space therein for storing the cat litter bags.

### BRIEF DESCRIPTION OF THE DRAWINGS

The invention will be more fully understood by reference to the detailed description in conjunction with the following figures, wherein:

FIG. 1 is a fragmentary view in perspective of a first embodiment litter bag holder coupled to a cat litter box or, alternatively, to a wall near the cat litter box, the first embodiment litter bag holder having a box-shaped housing and a first configuration drawer slidably disposed in the housing;

FIG. 2 is a view in elevation of the first embodiment litter bag holder coupled to the cat litter box;

FIG. 3 is a view in perspective of the first embodiment litter bag holder having the first configuration drawer slidably extended from the housing, this view also showing the first configuration drawer holding a plurality of litter bags;

FIG. 4 is a view taken along section line 4-4 of FIG. 2, this view showing the housing of the first embodiment litter bag holder coupled to the cat litter box by means of a first embodiment attachment arrangement including a brace having an adhesive backing, this view also showing the first configuration drawer slidably disposed within the housing;

FIG. 5 is a view in vertical section of the housing belonging to the first embodiment litter bag holder, the housing being coupled to the cat litter box by means of the brace having the adhesive backing, this view also showing the first configuration drawer slidably extended its fullest extent from the housing;

FIG. 6 is a fragmentary view in partial vertical section of the housing and first configuration drawer belonging to a second embodiment litter bag holder, the housing of the second embodiment litter bag holder being coupled to the cat litter box by means of a second embodiment attachment arrangement including an adhesive layer;

FIG. 7 is a fragmentary view in vertical section of the housing and first configuration drawer belonging to a third embodiment litter bag holder, the housing of the third embodiment litter bag holder being coupled to the cat litter box by means of a third embodiment attachment arrangement including a double-sided adhesive tape;

FIG. 8 is a fragmentary view in vertical section of the housing and first configuration drawer belonging to a fourth embodiment litter bag holder, the housing of the fourth embodiment litter bag holder being coupled to the cat litter box by means of a fourth embodiment attachment arrangement including a hook-and-loop fastener, a male member thereof adhesively coupled to the housing and a female member thereof adhesively coupled to the cat litter box;

FIG. 9 is a view in elevation of the housing and first configuration drawer belonging to a fifth embodiment litter bag holder, the housing of the fifth embodiment litter bag holder being coupled to the cat litter box by means of a fifth embodiment attachment arrangement including a first screw fastener configuration;

FIG. 10 is a view taken along section line 10-10 of FIG. 9, this view also showing the first screw fastener configuration including an externally threaded screw threadably engaging an internally threaded anchor integrally formed with the cat litter box;

FIG. 10A is a view in vertical section of the fifth embodiment litter bag holder, the housing being coupled to the cat litter box by means of the fifth embodiment attachment arrangement including an alternative second screw fastener configuration, the second screw fastener configuration including an the externally threaded screw threadably engaging an internally threaded hex-nut;

FIG. 11 is a fragmentary view in vertical section of a sixth embodiment litter bag holder, the sixth embodiment litter bag holder including a second configuration drawer having a bag support disposed therein and a biasing member coupled to the bag support;

FIG. 12 is a view in vertical section of a seventh embodiment litter bag holder, the seventh embodiment litter bag holder including a third configuration drawer having walls defining a plurality of laterally expandable and contractable flutes for expandably extending the drawer partially through an opening defined by the housing and for retracting the drawer through the opening;

FIG. 13 is a view in vertical section of the seventh embodiment litter bag holder, the seventh embodiment litter bag holder including the third configuration drawer having walls defining the plurality of laterally expandable and contractable flutes, the third configuration drawer having been expandably extended partially through the opening defined by the housing;

FIG. 14 is a fragmentary view taken along section line 14-14 of FIG. 12;

FIG. 15 is a fragmentary view taken along section line 15-15 of FIG. 13;

FIG. 16 is a view in perspective of an eighth embodiment litter bag holder, the eighth embodiment litter bag holder including a fourth configuration drawer having walls defining a plurality of laterally and downwardly expandable flutes for expandably extending the fourth configuration drawer in a downward arc from the opening defined by the housing;

FIG. 17 is a view in elevation of the eighth embodiment litter bag holder, the eighth embodiment litter bag holder including the fourth configuration drawer;

FIG. 18 is a view taken along section line 18-18 of FIG. 17;

FIG. 19 is a view in vertical section of the eighth embodiment litter bag holder, the eighth embodiment litter bag holder including the fourth configuration drawer having walls defining the plurality of laterally and downwardly expandable flutes, the drawer being shown as having been expandably extended in a downwardly-directed arc through the opening defined by the housing;

FIG. 20 is a front view in elevation of a ninth embodiment litter bag holder, the ninth embodiment litter bag holder comprising a sixth embodiment attachment arrangement that includes a mounting plate adhesively coupled to the litter box and a first bag closure dispenser containing a plurality of bag ties therein, a second bag closure dispenser containing a supply of adhesive tape, and a bag holder housing adhesively coupled to the mounting plate;

FIG. 21 is a view taken along section line 21-21 of FIG. 20;

FIG. 22 is a fragmentary view in perspective of a tenth embodiment litter bag holder, the tenth embodiment litter bag holder including a slotted housing and a mounting bracket adapted to couple the housing to the cat litter box;

FIG. 23 is a view in vertical section of the mounting bracket and housing adhesively coupled to the cat litter box;

FIG. 24 is a view in vertical section of an eleventh embodiment litter bag holder, the eleventh embodiment litter bag holder being integrally formed with the cat litter box, such that the eleventh embodiment litter bag holder and cat litter box form a single unit;

FIG. 24A is a view in vertical section of a twelfth embodiment litter bag holder, the twelfth embodiment litter bag holder comprising the first configuration drawer including a pivotable top wall;

FIG. 24B a view in vertical section of the twelfth embodiment litter bag holder, the twelfth embodiment litter bag holder having the first configuration drawer that includes the pivotable top wall, the pivotable top wall being shown in an open position while the first configuration drawer remains in the housing;

FIG. 24C a view in vertical section of the twelfth embodiment litter bag holder, the twelfth embodiment litter bag holder comprising the first configuration drawer that includes the pivotable top wall, the pivotable top wall being shown in a closed position while the first configuration drawer is extended from the housing;

FIG. 25 is a view in perspective of the first embodiment litter bag holder coupled to the cat litter box and also showing exemplary types of litter bags receivable in the litter bag holder; and

FIG. 26 is a flowchart showing an illustrative method of manufacturing the litter bag holder.

### DETAILED DESCRIPTION OF PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from either the spirit or scope of the invention.

In addition, the present patent specification uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

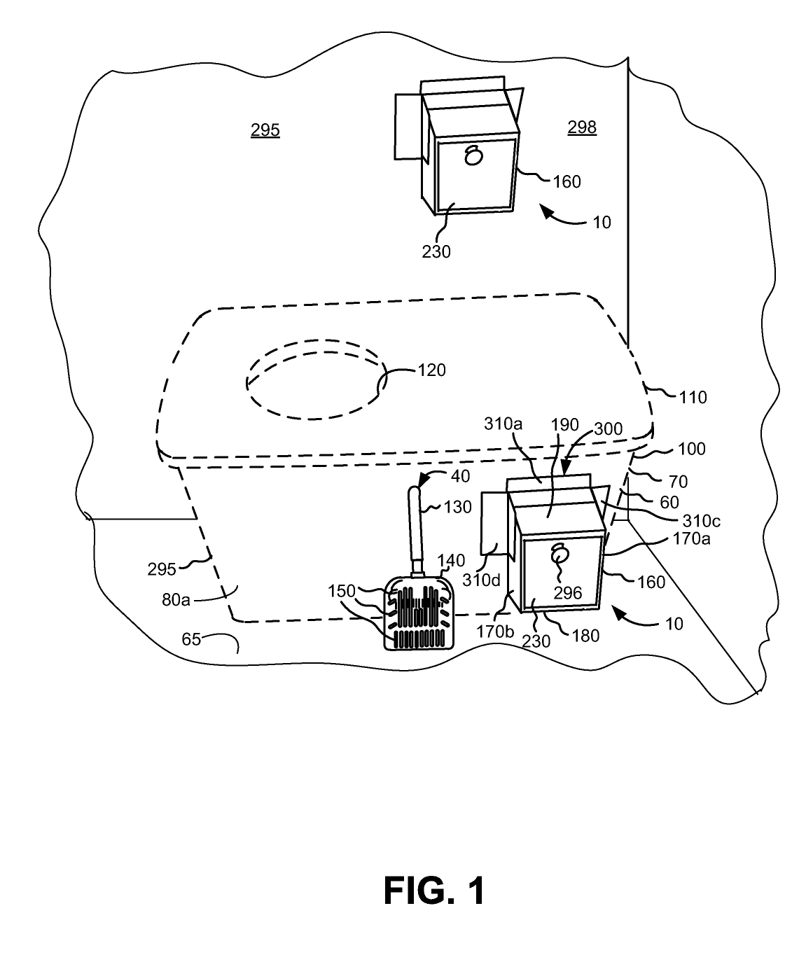

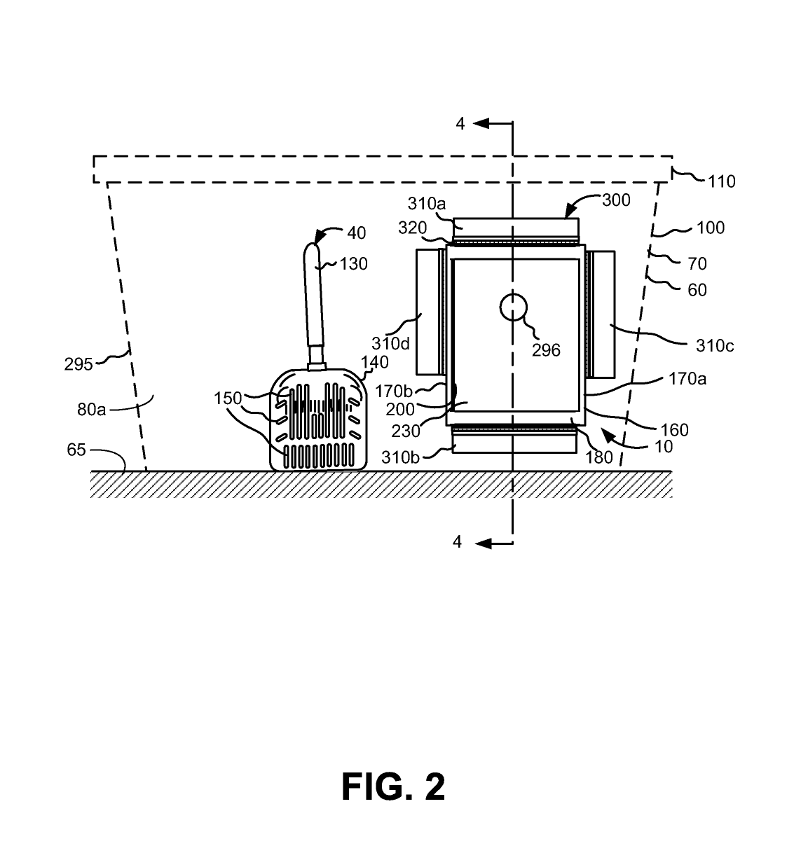

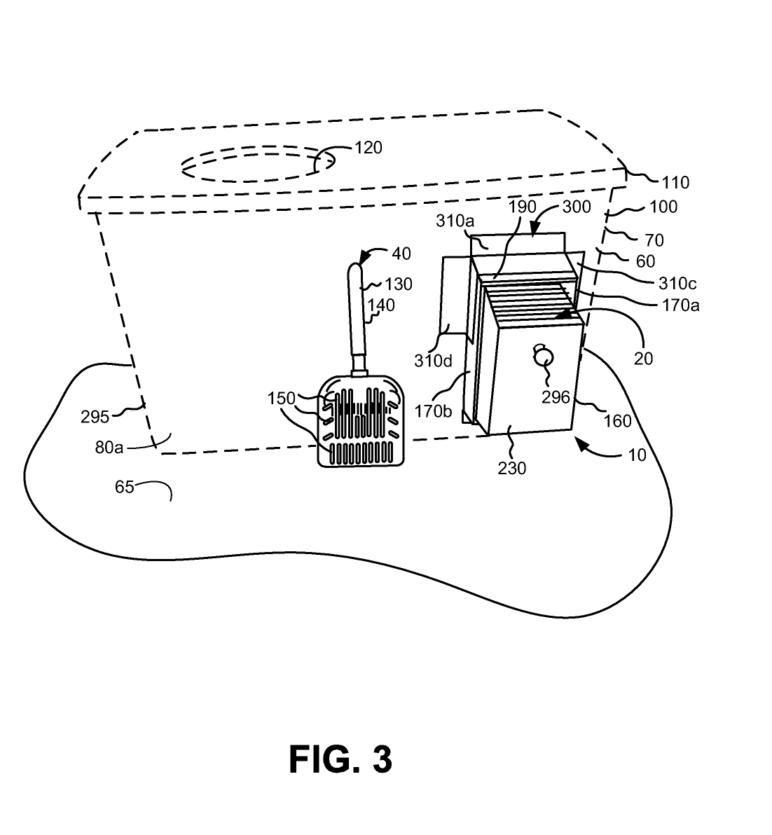

Therefore, with reference to FIGS. 1, 2, 3 and 4, there is shown a first embodiment litter bag holder, generally referred to as 10, for holding one or more litter bags, generally referred as 20. Each of the litter bags 20 is adapted to contain a plurality of cat litter waste clumps 30. In this regard, a litter scoop, generally referred to as 40, is used by a user (not shown) to sift, rake or scoop a plurality of the cat litter waste clumps 30 from cat litter 50 that is disposed in a cat litter box 60. Cat litter box 60 may be located at any suitable location, such as on a floor 65, on a counter top (not shown) or similar horizontal surface. A conventional, commercially available cat litter box 60 suitable for this purpose may be of a type, such as a “CLEVERCAT® TOP ENTRY CAT LITTER BOX”, that may be available from Clevercat Innovations, Incorporated located in Sarasota, Fla., U.S.A. The “CLEVERCAT® TOP ENTRY CAT LITTER BOX”, or similar litter box construction, comprises a base portion 70 having four substantially vertical, perpendicularly arranged, integrally connected side panels 80a and 80b (only two of the four side panels are shown). Litter box 60 also includes a horizontal bottom panel 90 integrally formed with all four side panels, including side panels 80a and 80b, so as to define an interior volume 95 of litter box 60. Bottom panel 90 supports waste litter clumps 30 and cat litter 50 thereon while waste litter clumps 30 and cat litter 50 are disposed in litter box 60. Each of the side panels and bottom panel 90 has an interior surface 97, as shown.

Referring again to FIGS. 1, 2, 3 and 4, litter box 60 has an open top end 100 for placement of cat litter 50 into litter box 60 and for removal of waste litter clumps 30 from litter box 50, the waste litter clumps 30 containing cat biological waste matter (i.e., urine soaked litter and feces). Mounted atop open top end 100 is a removable lid or cover 110. Cover 110 allows access to litter clumps 30 and cat litter 50 that is disposed in interior volume 95 of litter box 60 when cover 110 is removed and encloses litter clumps 30 and cat litter 50 in interior volume 95 when cover 110 is mounted atop open top end 100. Cover 110 defines an opening 120 therethrough for a cat (not shown) to enter and leave litter box 60.

Referring yet again to FIGS. 1, 2, 3 and 4, such conventional, commercially available cat litter boxes 60 may be made of any suitable material, such as polypropylene, acrylonitrile butadiene styrene (ABS), nylon, acetone or resin. However, according to the teachings herein, the material composition constituting such a conventional, commercially available litter box 60 can be enhanced. In this regard, the material comprising cat litter box 60 may include a pathogen resistant, antimicrobial, antifungal composition, such as the “VINYZENE™ IT 3025 DOTP ANTIMICROBIAL” composition that may be available from The Dow Chemical Company located in Midland, Mich., U.S.A. The “VINYZENE™ IT 3025 DOTP ANTIMICROBIAL” composition comprises 2-n-octyl-4-isothiazolin-3-one in a nonvolatile phthalate-free carrier that can be added to the plastic composition comprising litter box 60 during manufacture of litter box 60. Alternatively, litter box 60 may be made of metal, such as steel or aluminum. In this case, the metal may be coated, layered or otherwise painted during manufacture with a pathogen resistant, antimicrobial, antifungal composition, such as a composition having silver (Ag) as an active ingredient. Such a commercially available coating containing silver and that is suitable for this purpose may be of a type, such as the “AGION” compound, that may be available from AgION® Technologies, Incorporated located in Wakefield, Mass., U.S.A. The “AGION” compound combines silver with an inorganic ceramic that permits a continuous, controlled release of ionic silver over an extended time period in such a manner that inhibits growth of microbes. Inhibiting growth of microbes, whether litter box 60 is formed of plastic or metal, is important in order to help maintain litter box 60 in a sanitary condition, so that risk to human health is reduced.

Cat litter 50 is selected from any of the known cat litter compositions. However, a type of cat litter 50 that is preferred by many cat owners is “clumping litter.” Clumping litter may comprise bentonite clay (absorbent aluminum phyllosilicate) or diatomaceous earth, which forms a relatively solid mass or clump 30 when wet. Any clumps 30 can then be scooped, raked or otherwise sifted from cat litter 50 without emptying the entire contents of litter box 60.

Previously mentioned litter scoop device 40, which forms no part of the present invention, is used to sift, rake or scoop clumps 30 from cat litter 50 that are disposed in litter box 60. In this regard, litter scoop device 40 comprises an elongate handle 130 attached to a perforate blade member 140. More specifically, blade member 140 defines a plurality of perforations 150 therethrough sized to allow unclumped litter material to pass through perforations 150 while simultaneously retaining waste litter clumps 30 on blade member 140. Clumps 30 are subsequently discarded, such as in the manner described hereinbelow.

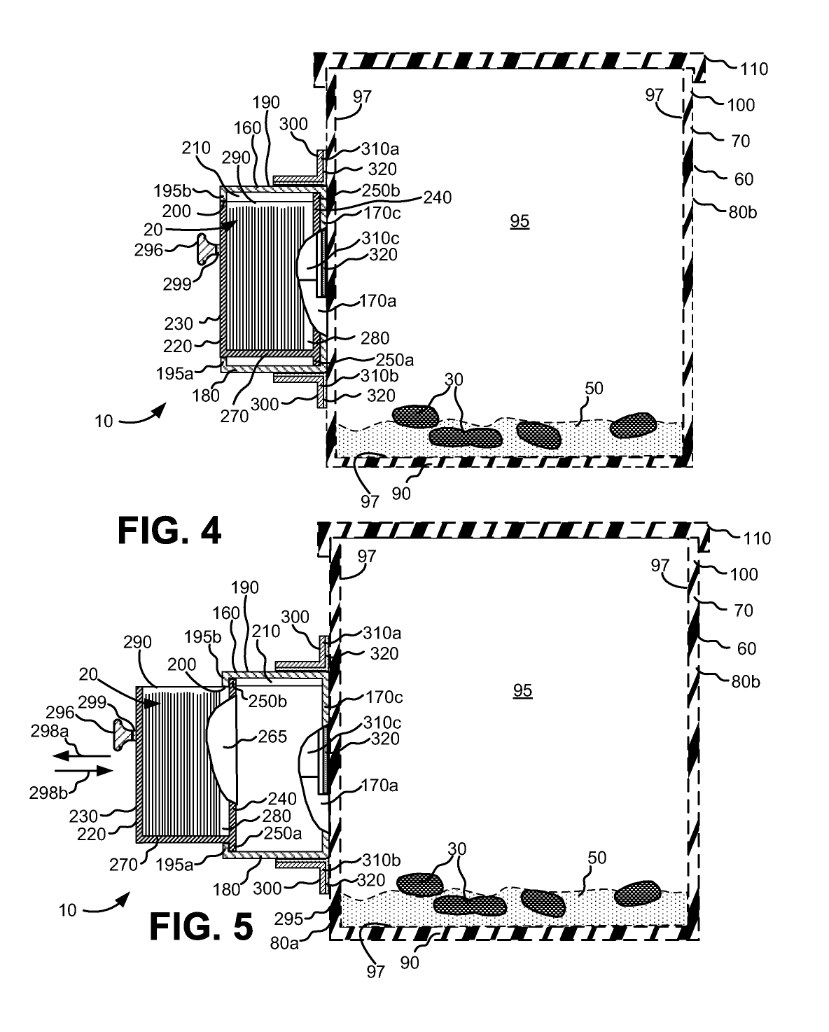

Still referring to FIGS. 1, 2, 3 and 4, first embodiment litter bag holder 10 comprises a box-shaped housing 160 that includes a vertical right sidewall 170a (shown in broken section in FIGS. 4 and 5) and a vertical left sidewall 170b oppositely disposed with respect to right sidewall 170a and spaced-apart therefrom. Right sidewall 170a and left sidewall 170b are parallel to each other. In addition, right sidewall 170a and left sidewall 170b are each perpendicular to a vertical rear sidewall 170c and integrally attached thereto. Also, a horizontal floor or bottom wall 180 is integrally attached to bottom end portions of sidewalls 170a, 170b, and 170c. In addition, a stationary, horizontal ceiling or top wall 190 is integrally attached to top end portions of sidewalls 170a, 170b, and 170c. Integrally attached to a front end portion of bottom wall 180 is an upwardly-directed lip portion, step or first abutment 195a for reasons disclosed hereinbelow. Also, integrally attached to a front end portion of top wall 190 is a downwardly-directed lip portion, step or second abutment 195b for reasons disclosed hereinbelow. There is no front wall to housing 160. Rather, sidewalls 170a/170b/170c, bottom wall 180 and top wall 190 define an opening 200 at the front of housing 160 and also define a cavity 210 within housing 160, the opening 200 being in communication with cavity 210 for reasons provided hereinbelow.

Referring to FIGS. 1, 2, 3, 4 and 5, a first configuration drawer 220 is slidably disposed in cavity 210 that is defined by housing 160. First configuration drawer 220 has a substantially rigid or inflexible construction and comprises a vertical front plate 230 and a vertical rear plate 240 parallel to front plate 230 and spaced-apart therefrom. Rear plate 240 includes a lower leg end portion 250a for abutting previously mentioned first abutment 195a and an upper leg end portion 250b for abutting previously mentioned second abutment 195b. Lower leg end portion 250a and upper leg end portion 250b will abut first abutment 195a and second abutment 195b, respectively, when first configuration drawer 200 is caused to slide a sufficient distance in cavity 210, generally in the direction of directional arrow 298a. Thus, it may be appreciated that the abutting engagement of lower leg end portion 250a and first abutment 195a and the simultaneous abutting engagement of upper leg end portion 250b with second abutment 195b limits travel of first configuration drawer 220 in cavity 210, so that first configuration drawer 220 will not completely exit out opening 200. In this manner, first configuration drawer 220 remains slidably coupled to housing 160.

Referring again to FIGS. 1, 2, 3, 4 and 5, first configuration drawer 220 further comprises a vertical left side plate 260 and a vertical right side plate 265 (shown in broken section in FIG. 5) parallel to left side plate 260 and spaced-apart therefrom. As shown in FIGS. 1, 2, 3, 4, and 5, left side plate 260 and right side plate 265 are each perpendicular to front plate 230 and rear plate 240 and integrally attached thereto. Integrally attached to lower ends of front plate 230, left side plate 260, right side plate 265, and to a lower portion of rear plate 240 is a horizontally-oriented bottom plate 270. Therefore, front plate 230, rear plate 240, left side plate 260, right side plate 265, and bottom plate 270 define a storage space 280 in first configuration drawer 220 for stowing previously mentioned cat litter bags 20. In addition, it should be appreciated that front plate 230, rear plate 240, left side plate 260, right side plate 265, and bottom plate 270 further define an upper opening 290 for placing cat litter bags 20 into storage space 280 and for retrieving cat litter bags 20 from storage space 280. A knob 296 is affixed to front plate 230, such as by a screw (not shown) or adhesive joint 299, for moving first configuration drawer 220 in direction of horizontal directional arrow 298a and in direction of a horizontal directional arrow 298b, as shown.

Referring again to FIGS. 1, 2, 3, 4 and 5, housing 160 and first configuration drawer 220 may be made of any suitable material, such as polypropylene, acrylonitrile butadiene styrene (ABS), nylon, acetone or resin. In addition, the material comprising housing 160 and first configuration drawer 220 may include a pathogen resistant, antimicrobial, antifungal composition, such as the previously mentioned “VINYZENE™ IT 3025 DOTP ANTIMICROBIAL” composition that can be added to the plastic composition comprising housing 160 and first configuration drawer 220 during manufacture of housing 160 and first configuration drawer 220. Alternatively, housing 160 and first configuration drawer 220 may be made of metal, such as steel or aluminum. In this case, the metal may be coated, layered or otherwise painted during manufacture with a pathogen resistant, antimicrobial, antifungal composition having silver (Ag) as an active ingredient. A commercially available coating containing silver and that is suitable for this purpose may be the previously mentioned “AGION” compound that inhibits growth of microbes. Inhibiting growth of microbes, whether housing 160 and first configuration drawer 220 are formed of plastic or metal, is important in order to help maintain first embodiment bag holder 10 in a sanitary condition given its proximity to contaminated litter 50 in litter box 60, so that risk to human health is reduced.

As best seen in FIG. 1, first embodiment bag holder 10 is adapted to be connected to any of the side panels belonging to cat litter box 60, such as side panels 80a or 80b, so that first embodiment bag holder 10 is conveniently accessible by the user. Alternatively, first embodiment bag holder 10 may be connected to a nearby wall 293. Thus, the side panels belonging to cat litter box 60, such as to side panels 80a or 80b, or wall 293 provide support structure for supporting first embodiment bag bolder 10 thereon.

As seen in FIGS. 1, 4 and 5, first embodiment bag holder 10 is coupled to cat litter box 60, such as to side panels 80a or 80, wall 293 or similar structure (hereinafter collectively referred to as “support structure 295”) by a first embodiment attachment arrangement, generally referred to as 300. First embodiment attachment arrangement 300 includes a plurality of right-angle adhesive braces. The plurality of right-angle braces includes an uppermost brace 310a, a lowermost brace 310b, a right side brace 310c and a left side brace 310d. Each brace 310a/b/c/d has an adhesive backing 320 adapted to adhesively connect braces 310a/b/c/d to support structure 295 and to housing 160. More specifically, uppermost brace 310a in combination with its adhesive backing 320 adhesively connects top wall 190 of housing 160 to support structure 295. Lowermost brace 310b in combination with its adhesive backing 320 adhesively connects bottom wall 190 of housing 160 to support structure 295. Right side brace 310c in combination with its adhesive backing 320 adhesively connects right side wall 170a of housing 160 to support structure 295. Left side brace 310d in combination with its adhesive backing 320 adhesively connects left side wall 170b of housing 160 to support structure 295. In this manner, braces 310a/b/c/d in combination with their adhesive backings 320 support housing 160 while adhesively connecting housing 160, and thus first embodiment bag holder 10, to support structure 295. Adhesive backing 320 may comprise a permanent adhesive, such as an acrylic adhesive that provides high bond strength and that can be used to permanently affix housing 160 to support structure 295 during manufacture of litter box 10. Alternatively, if desired, adhesive backing 320 may comprise a peelable, non-permanent adhesive, so that first embodiment bag holder 10 may be peeled away or easily separated from support structure 295 when desired. It may be desirable to have first embodiment bag holder 10 peeled away or separated from support structure 295 should first embodiment bag holder 10 need replacement due to damage or deterioration caused by extensive use. Such a peel-away adhesive suitable for this purpose can be an epoxy adhesive. It should be appreciated that braces 310a/b/c/d in combination with the peelable, non-permanent adhesive backing allow first embodiment bag holder 10 to be marketed and sold separately from cat litter box 40. In other words, first embodiment bag holder 10 can be separately marketed and sold as an accessory for semi-permanent attachment to cat litter box 60 in order to allow convenient replacement of first embodiment bag holder 10 when required.

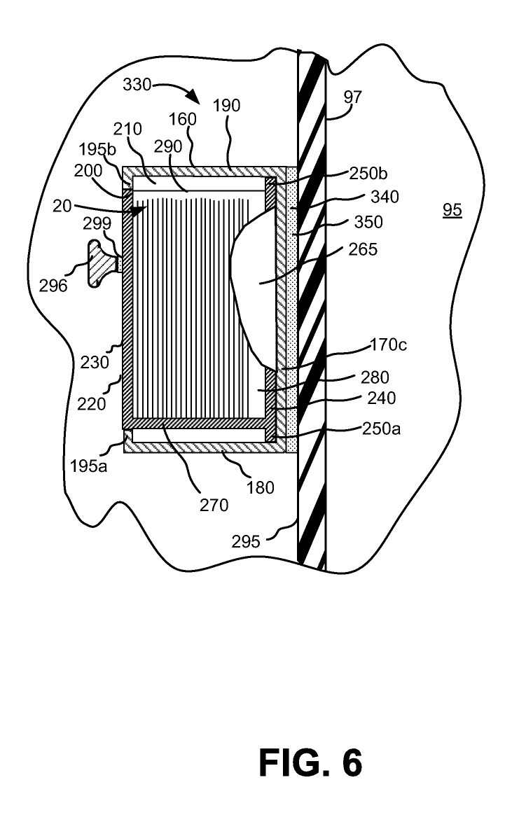

Turning now to FIG. 6, a second embodiment litter bag holder, generally referred to as 330, is provided for holding one or more litter bags 20. Second embodiment litter bag holder 330 is substantially similar to first embodiment litter bag holder 10, except first embodiment attachment arrangement 300 comprising braces 310a/b/c/d in combination with adhesive backing 320 is omitted. Rather, a second embodiment attachment arrangement 340 is provided that includes an adhesive layer 350 interposed between rear plate 240 of housing 160 and support structure 295. Size of adhesive layer 350 may be coextensive with the size (i.e., height and width) of rear plate 240 for a more aesthetic or visually appealing appearance because the edges of adhesive layer 350 will not extend beyond the edges of rear plate 240. Adhesive layer 350 bonds housing 160 to support structure 295, and therefore bonds second embodiment litter bag holder 330 to support structure 295. Adhesive layer 350 may comprise a permanent adhesive, such as an acrylic adhesive, permanently affixing housing 160 to support structure 295. Alternatively, if desired, adhesive layer 350 may comprise a peelable, non-permanent adhesive, such as an epoxy adhesive. Use of a peelable, non-permanent adhesive, allows second embodiment bag holder 330 to be peeled away or easily separated from support structure 295 when desired. It may be desirable to have second embodiment bag holder 330 peeled away or easily separated from support structure 295 should second embodiment bag holder 330 need replacement due to damage, deterioration or other reason.

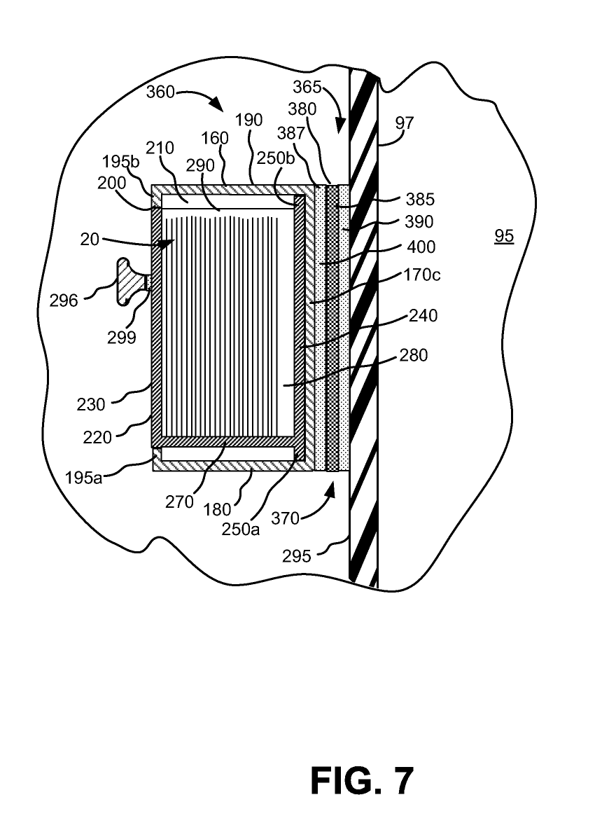

Referring to FIG. 7, a third embodiment litter bag holder, generally referred to as 360, is there shown. Third embodiment litter bag holder 360 is substantially similar to second embodiment litter bag holder 330, except second embodiment attachment arrangement 340 comprising adhesive layer 350 is omitted and replaced with a third embodiment attachment arrangement, generally referred to as 365. The third embodiment attachment arrangement 365 comprises a self-adhesive, double-sided tape, generally referred to as 370. Double-sided tape 370 comprises a central sheet 380, which may be polyester, having a rear surface 385 and a front surface 387. Interposed between rear surface 385 of double-sided tape 370 and support structure 295 is a first adhesive film 390 for adhesively connecting double-sided tape 370 to support structure 295. In addition, interposed between front surface 387 of double-sided tape 370 and rear sidewall 170c of housing 160 is a second adhesive film 400 for adhesively connecting double-sided tape 370 to housing 160. Either or both of first adhesive film 390 and second adhesive film 400 may be a permanent adhesive, such as an acrylic adhesive, permanently affixing double-sided tape 370, and thus housing 160, to support structure 295. Alternatively, if desired, either or both of first adhesive film 390 and second adhesive film 400 may be a peelable, non-permanent adhesive, such as an epoxy adhesive for reasons recited hereinabove.

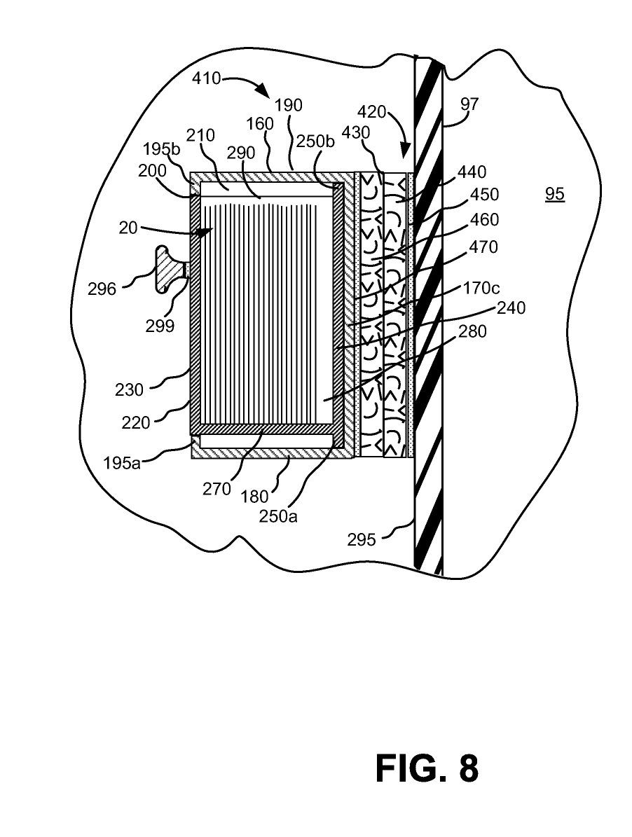

With reference to FIG. 8, there is shown a fourth embodiment litter bag holder, generally referred to as 410. Fourth embodiment litter bag holder 410 is substantially similar to third embodiment litter bag holder 360, except third embodiment attachment arrangement 365 comprising double-sided tape 370 is omitted and replaced with a fourth embodiment attachment arrangement, generally referred to as 420. The fourth embodiment attachment arrangement 420 comprises a hook-and-loop fastener 430 including a female member 440. A first adhesive laminate 450 is interposed between female member 440 and support structure 295 for adhesively coupling female member 440 to support structure 295. Hook-and-loop fastener 430 also includes a male member 460. A second adhesive laminate 470 is interposed between male member 460 and rear sidewall 170c of housing 160 for adhesively coupling male member 460 to housing 160. Male member 460 is adapted to intimately engage female member 440, such that housing 160 is coupled to support structure 295. Hook-and-loop fastener 430 may be a “VELCRO® brand fastener” that is available from Velcro Industries B.V. located in Amsterdam, The Netherlands.

Still referring to FIG. 8, either or both of first adhesive laminate 450 and second adhesive laminate 470 may be a permanent adhesive, such as an acrylic adhesive, permanently affixing female member 440 to support structure 295 and permanently affixing male member 460 to rear sidewall 170c of housing 160. Alternatively, if desired, either or both of first adhesive laminate 450 and second adhesive laminate 470 may be a peelable, non-permanent adhesive, such as an epoxy adhesive. It should be appreciated by a person of ordinary skill in the art that use of hook-and-loop fastener 430 allows fourth embodiment litter bag holder 410 to be releasably secured to support structure 295 regardless of whether a permanent or a peelable adhesive is used.

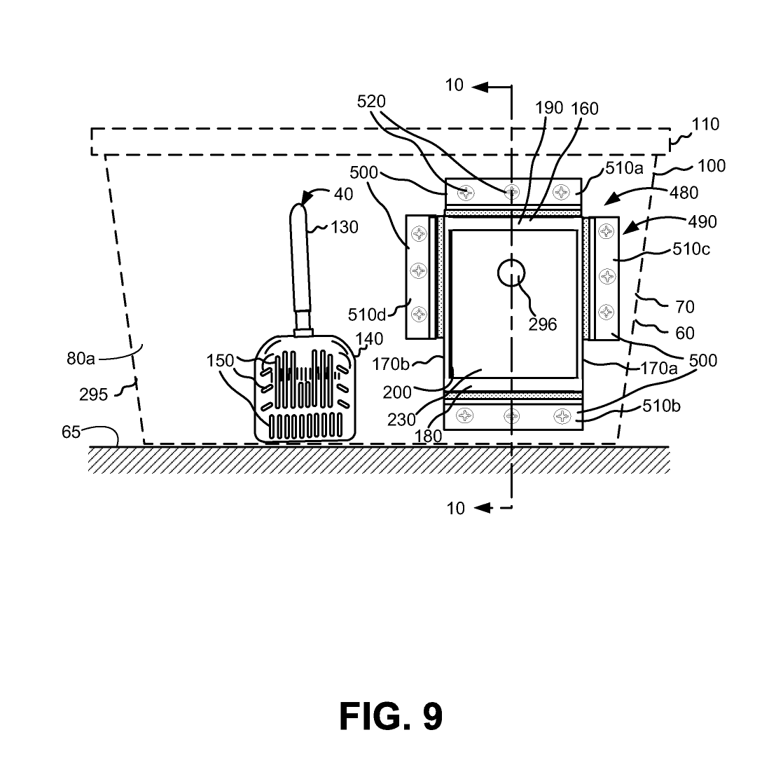

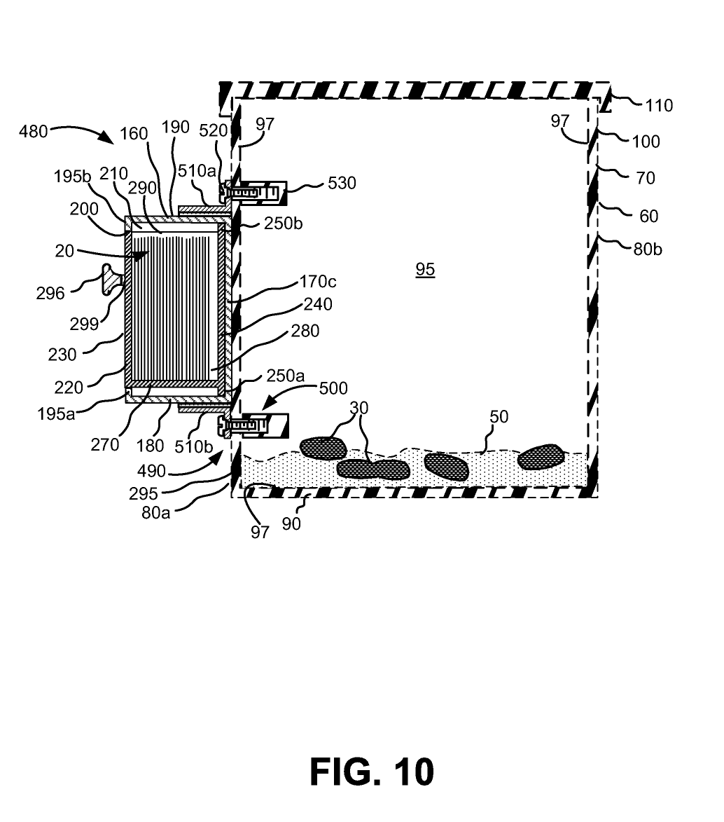

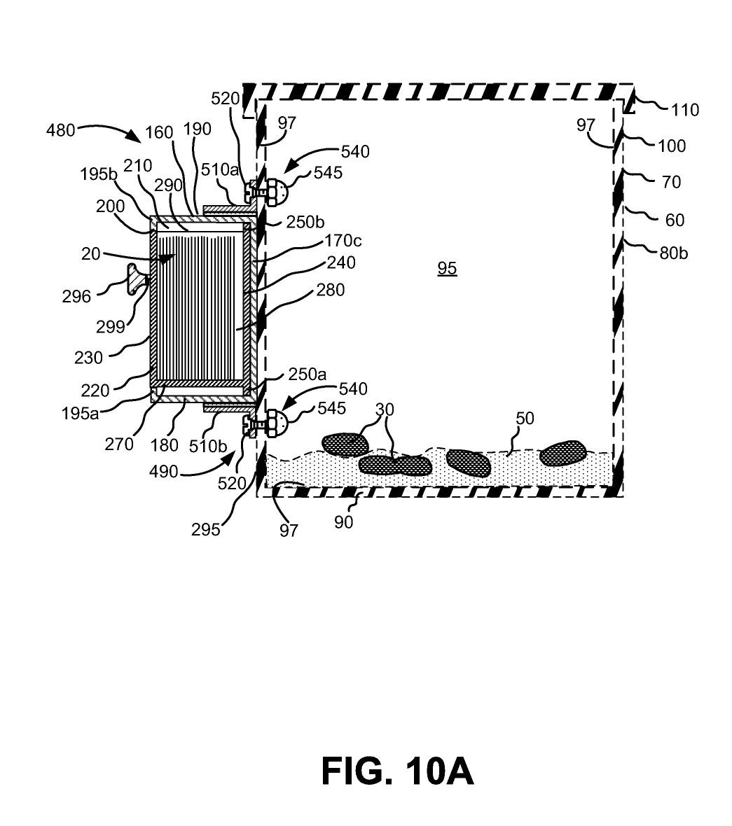

In FIGS. 9 and 10, a fifth embodiment litter bag holder, generally referred to as 480, is shown coupled to support structure 295 by means of a fifth embodiment attachment arrangement, generally referred to as 490. The fifth embodiment attachment arrangement 490 includes a first screw fastener configuration 500. First screw fastener configuration 500 includes a plurality of right-angle screw braces 510a/b/c/d of shape similar to previously mentioned right-angle adhesive braces 310a/b/c/d. As previously mentioned, adhesive braces 310a/b/c/d are connected to support structure 295 by means of adhesive backing 320. However, screw braces 510a/b/c/d, on the other hand, are connected to support structure 295 by means of a plurality of externally threaded screws 520 penetrating through any one of screw braces 510a/b/c/d and a selected one of side panels (e.g., side panel 80a or side panel 80b) belonging to support structure 295 (e.g., cat litter box 60). As screws 520 penetrate through braces 510a/b/c/d and the selected one of the side panels, the externally threaded screws 520 engage respective ones of a plurality of internally threaded anchors 530 disposed in interior volume 95 and integrally formed with support structure 295. Each anchor 530 is disposed so as to be aligned with its respective screw 520 and is integrally formed with previously mentioned interior surface 97 of support structure 295, as shown. Thus, fifth embodiment bag holder 480 is secured to support structure 295 as each externally threaded screw 520 penetrates through its respective brace 510a/b/c/d and the support structure 295 and is threadably received in internally threaded anchor 530.

In FIG. 10A, fifth embodiment litter bag holder 480 is shown coupled to support structure 295 by means of fifth embodiment attachment arrangement 490. However, fifth embodiment attachment arrangement 490 includes a second screw fastener configuration 540. Second screw fastener configuration 540 includes previously mentioned plurality of right-angle screw braces 510a/b/c/d. As stated hereinabove, screw braces 510a/b/c/d are connected to support structure 295 by means of the plurality of externally threaded screws 520 penetrating through any one of screw braces 510a/b/c/d and a selected one of the side panels (e.g., side panel 80a or side panel 80b) belonging to support structure 295 (e.g., cat litter box 60). However, according to this fifth embodiment litter bag holder 460, as screws 520 penetrate through braces 510a/b/c/d and the selected one of the side panels, the externally threaded screws 520 engage respective ones of a plurality of internally threaded hex-nuts 545 disposed in interior volume 95 that is defined by support structure 295. Each hex-nut 545 is disposed so as to be aligned with its respective screw 520, as shown. Thus, fifth embodiment bag holder 480 is secured to support structure 295 as each externally threaded screw 520 penetrates through its respective brace 510a/b/c/d and the support structure 295 and is threadably received in internally threaded hex-nut 545. Thus, second screw fastener configuration 540 provides an alternative means for connecting fifth embodiment bag holder 480 to support structure 295.

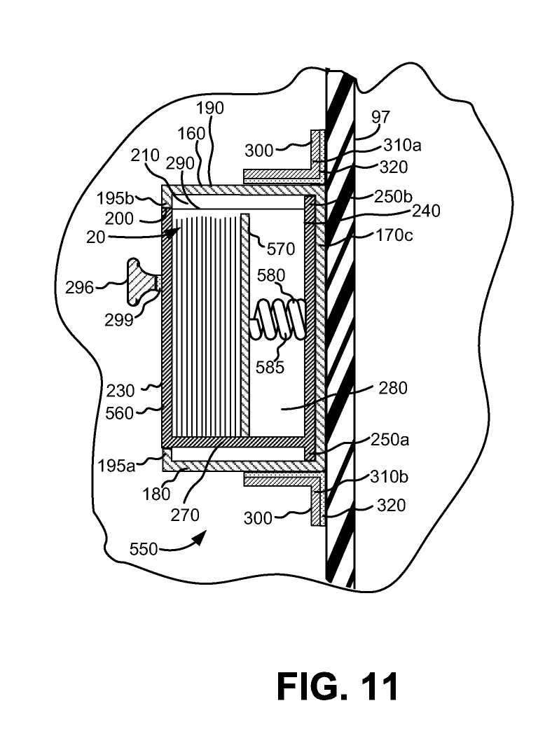

As shown in FIG. 11, a sixth embodiment litter bag holder, generally referred to as 550, comprises a second configuration drawer 560. The second configuration drawer 560 has an upright bag support 570 movably disposed in storage space 280 that is defined by second configuration drawer 560. Interposed between and connected to rear plate 240 and bag support 570 is a biasing member 580, such as a coiled spring, for biasing the plurality of cat litter bags 20 toward a front portion of second configuration drawer 560 and for maintaining cat litter bags 20 in a tightly-packed organized grouping. The spring constant for biasing member 580 is selected so that biasing member 580 will apply the necessary compressive force against bag support 570 to maintain litter bags 20 in the tightly-packed organized grouping regardless of the number of litter bags 20 present. Biasing cat litter bags 20 toward the front portion of second configuration drawer 560 and maintaining cat litter bags 20 in a tightly-packed, organized grouping provide the user with convenient access to cat litter bags 20 because cat litter bags 20 remain organized and grouped together at the front portion of the drawer rather than being scattered, randomly disposed or even entangled within storage space 280 defined by second configuration drawer 560. In addition, biasing cat litter bags 20 toward the front portion of second configuration drawer 560 avoids the user having to reach to the rear of the drawer to retrieve one or more cat litter bags 20 that may be located at the rear of the drawer. Requiring the user to reach to the rear of the drawer to retrieve cat litter bags 20 may be an inconvenience for some users and a disincentive for those users to utilize cat litter bags 20.

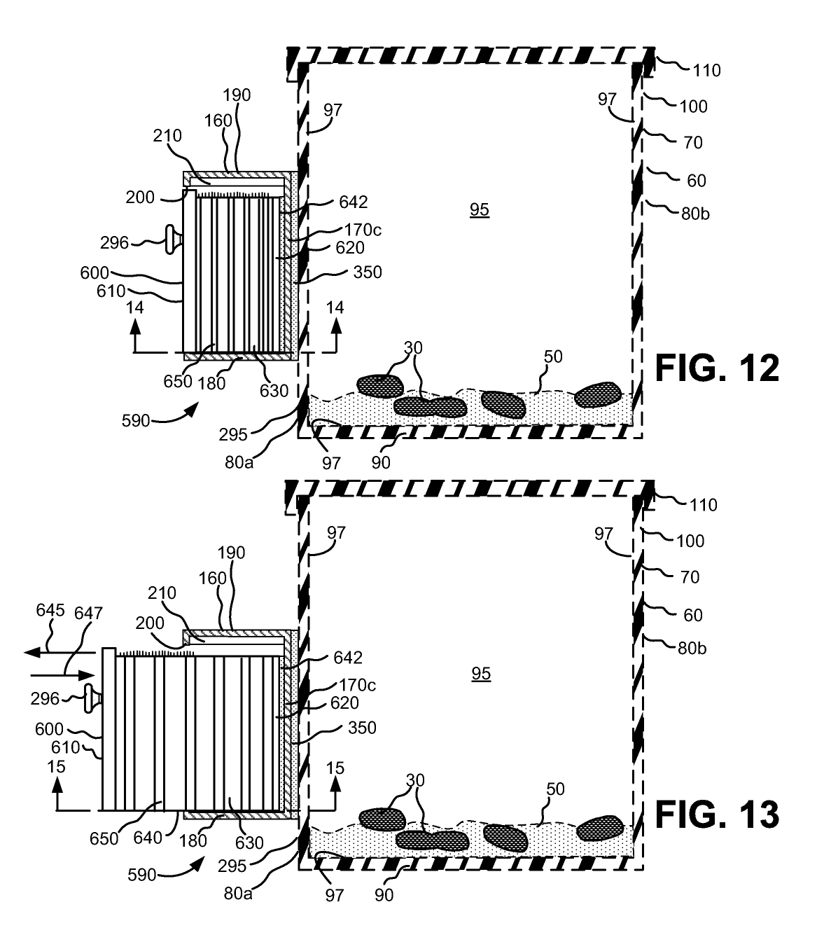

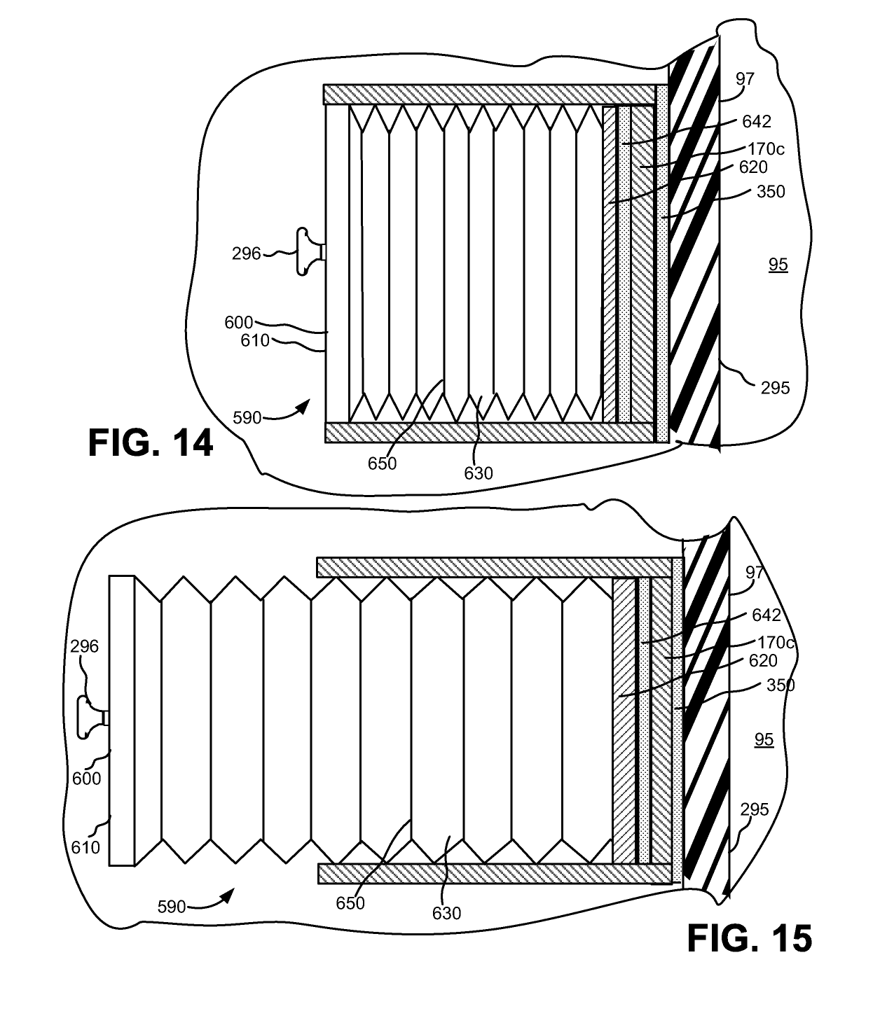

Referring to FIGS. 12, 13, 14 and 15, a seventh embodiment litter bag holder, generally referred to as 590, comprises a third configuration drawer 600. The third configuration drawer 600 comprises a vertical front wall 610 and a vertical rear wall 620 parallel to front wall 610 and spaced-apart therefrom. Third configuration drawer 600 further comprises a vertical left side wall 625 and a vertical right side wall 630 parallel to left side wall 625 and spaced-apart therefrom. Left side wall 625 and right side wall 630 are each perpendicular to front wall 610 and rear wall 620 and integrally attached thereto. Integrally attached to lower ends of front wall 610, left side wall 625, right side wall 630, and rear wall 620 is a horizontally-oriented floor 640. Rear wall 620 of third configuration drawer 300 is affixed to rear side wall 170c of housing 160 by an adhesive layer 642, such as an acrylic permanent adhesive or an epoxy nonpermanent (i.e., peelable) adhesive. Rear side wall 170c, in turn, is connected to support structure 295 by previously mentioned adhesive layer 350. Therefore, front wall 610, rear wall 620, left side wall 625, right side wall 630, and floor 640 define previously mentioned storage space 280 (see FIG. 11) in third configuration drawer 300 for stowing cat litter bags 20. In addition, with reference to FIGS. 12, 13, 14 and 15, it should be appreciated that front wall 610, rear wall 620, left side wall 625, right side wall 630, and floor 640 further define previously mentioned upper opening 290 for placing cat litter bags 20 into storage space 280 and for retrieving cat litter bags 20 from storage space 280. Previously mentioned knob 297 is affixed to front wall 610 for manually moving third configuration drawer 300 in direction of a horizontal directional arrow 645 and a horizontal directional arrow 647, as shown. Left side wall 625, right side wall 630 and floor 640 have a plurality of grooves, ribs, ruffles, pleats or flutes 650 formed therein for reasons disclosed hereinbelow.

Referring again to FIGS. 12, 13, 14 and 15, flutes 650 that are formed in left side wall 625 and right side wall 630 extend vertically and flutes 650 that are formed in floor 640 extend horizontally and are oriented perpendicularly with respect to flutes 650 formed in side walls 625/630. Flutes 650 formed in walls 625/630 and floor 640 are laterally expandable and contractable along directional arrow 645 and directional arrow 647. Thus, flutes 650 allow third configuration drawer 600 to laterally extend partially through opening 200 defined by housing 160 and laterally retract through opening 200. In other words, third configuration drawer 600 expands in the direction of directional arrow 645 in an accordion-like fashion when knob 297 is pulled by the user and retracts in the direction of directional arrow 647 in an accordion-like fashion when knob 297 is pushed by the user. Expansion and contraction of third configuration drawer 600 allows the volume of storage space 280, which is defined by third configuration drawer 600, to vary from a predetermined minimum volume to a predetermined maximum volume in order to accommodate varying numbers of litter bags 20. Thus, in this sense, third configuration drawer 600 is adjustable in size to accommodate more or fewer litter bags 20. Stowage of more litter bags 20 in third configuration drawer 600 may be more convenient for some users because the user will not need to find and refill third configuration drawer 600 with litter bags 20 as often. Reducing the frequency of finding and refilling third configuration drawer 600 with litter bags 20 encourages the user to utilize litter bags 20.

Referring yet again to FIGS. 12, 13, 14 and 15, left side wall 625, right side wall 630 and floor 640 may be made of any suitable material, such as any of the known elastomeric polymers capable of expanding and contracting. In addition, the material comprising housing 160 and third configuration drawer 600 may include a pathogen resistant, antimicrobial, antifungal composition, such as the previously mentioned “VINYZENE™ IT 3025 DOTP ANTIMICROBIAL” composition for the reasons recited hereinabove. Alternatively, housing 160 and third configuration drawer 600 may be coated, layered or otherwise painted with a pathogen resistant, antimicrobial, antifungal composition having silver (Ag) as an active ingredient for the reasons recited hereinabove. Use of the pathogen resistant, antimicrobial, antifungal composition inhibits growth of microbes. Inhibiting growth of microbes is important in order to help maintain seventh embodiment bag holder 590 in a sanitary condition given its proximity to contaminated litter 50 in litter box 60, so that risk to human health is reduced.

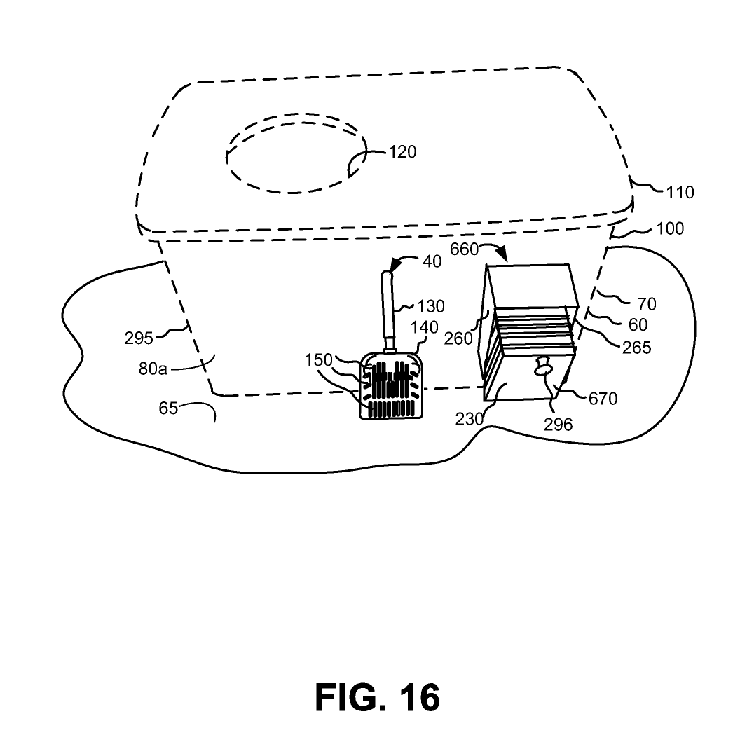

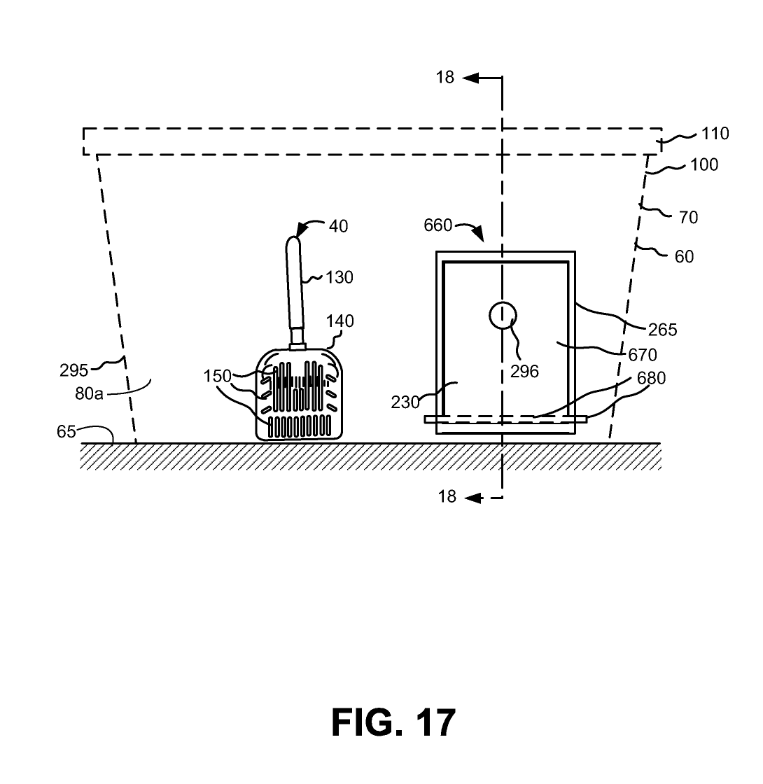

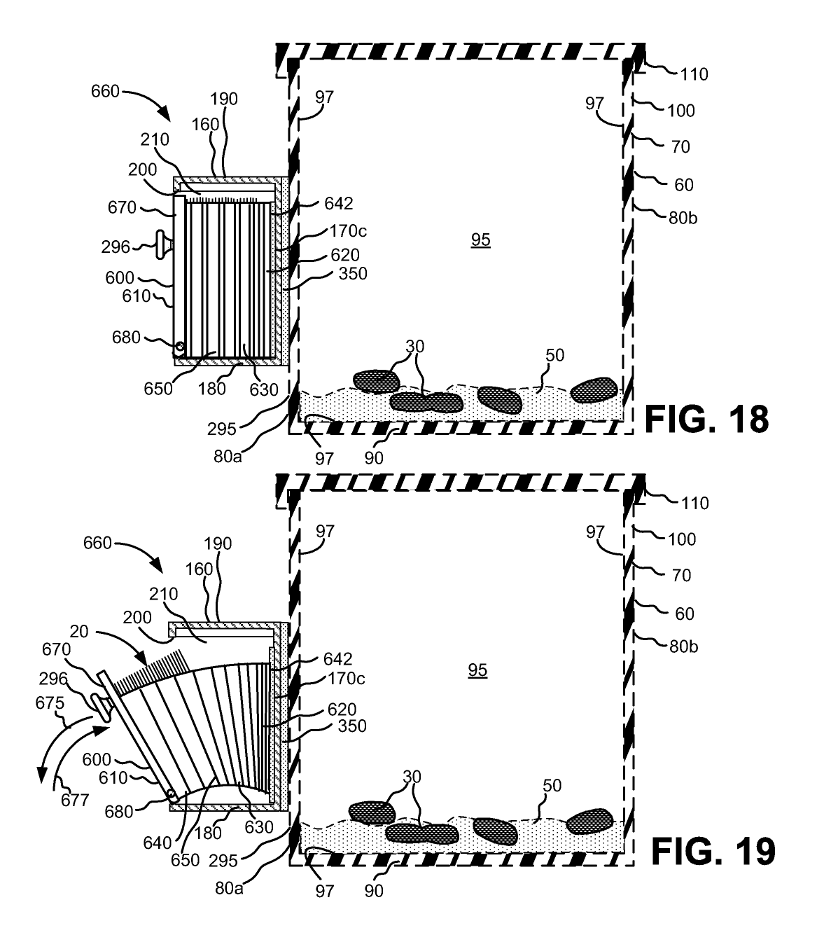

With reference to FIGS. 16, 17, 18 and 19, there is shown an eighth embodiment litter bag holder, generally referred to as 660, for holding one or more litter bags 20. Eighth embodiment litter bag holder 660 includes a fourth configuration drawer 670. Fourth configuration drawer 670 is substantially similar to third configuration drawer 600, except fourth configuration drawer 670 is downwardly extendable from opening 200 in a downwardly-directed arc in direction of a directional arrow 675 and upwardly contractible in an upwardly-directed arc in direction of a directional arrow 677. To achieve this result, an elongate pivot pin 680 extends from a bottom portion of right side wall 265, through a bottom portion of front plate 230, and to a bottom portion of left side wall 260. Thus, front plate 230 freely rotates about pivot pin 680 to allow front plate 230, and therefore fourth configuration drawer 670, to expand in the direction of directional arrow 675 and to contract in the direction of directional arrow 677. This fourth configuration drawer 670 can allow more litter bags 20 to be more quickly visible to and accessible by the user compared to third configuration drawer 600. Allowing litter bags 20 to be more quickly visible to and accessible by the user encourages the user to utilize litter bags 20. Also, fourth configuration drawer 670 uses less space to open compared to third configuration drawer 600 due to the arched or bending motion of fourth configuration drawer 670 when fourth configuration drawer 670 is opened. Using less space to open fourth configuration drawer 670 is desirable in cramped environments having reduced available space.

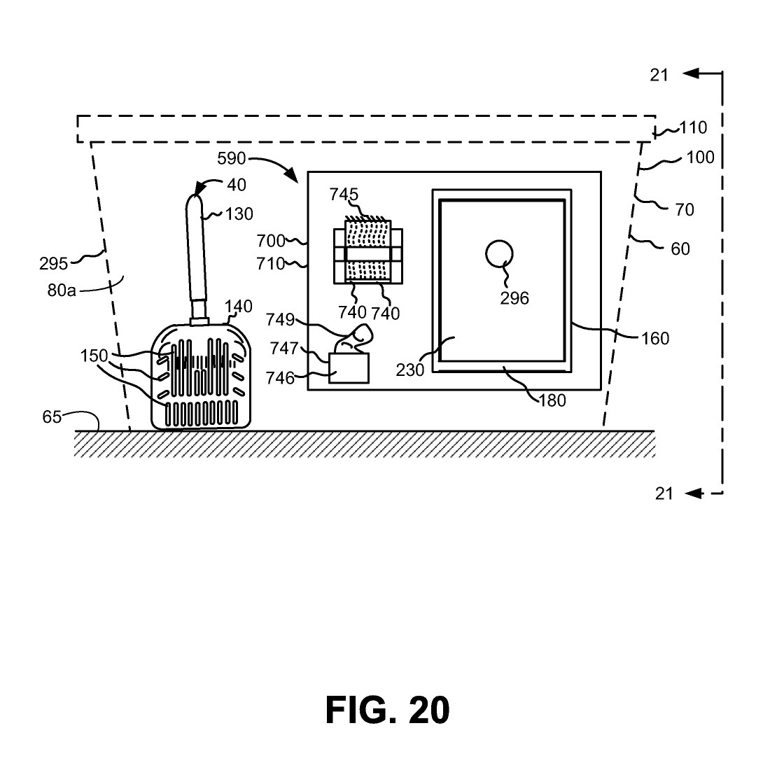

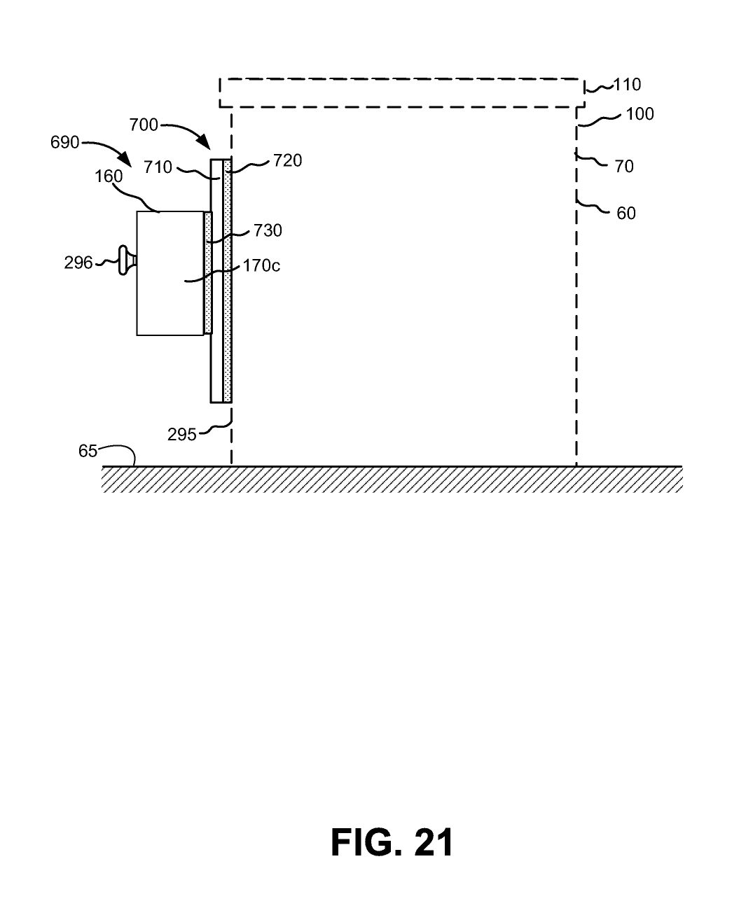

Referring to FIGS. 20 and 21, a ninth embodiment litter bag holder, generally referred to as 690, is there shown. Ninth embodiment litter bag holder 690 comprises a sixth embodiment attachment arrangement 700. The sixth embodiment attachment arrangement 700 includes a mounting plate 710 adhesively coupled to support structure 295 by means of a first adhesive layer 720, which may be a permanent adhesive (e.g., acrylic adhesive) or a peelable, nonpermanent adhesive (e.g., epoxy adhesive) or hook-and-loop fasteners (not shown). Moreover, if desired, mounting plate 710 may be coupled to support structure 295 by alternative means, such as screws (also not shown). Housing 160 is adhesively coupled to mounting plate 710 by means of a second adhesive layer 730, which may be a permanent adhesive (e.g., acrylic adhesive) or a peelable, nonpermanent adhesive (e.g., epoxy adhesive). However, if desired, housing 160 may be coupled to mounting plate 710 by alternative means, such as screws (not shown) or hook-and-loop fasteners (also not shown). In addition, a first closure dispenser 740, such as a tie dispenser 743, may be coupled to mounting plate 710 for providing a source of bag ties 745 adapted to tie-off open ends of litter bags 20 after cat litter waste clumps 30 are placed therein. A second bag closure dispenser 746, such as a tape dispenser 747, may be adhesively coupled to mounting plate 710 for dispensing adhesive tape 749. Tape dispenser 747 rather than, or in addition to, bag tie dispenser 743, can be used for closing litter bags 20 after cat litter waste clumps 30 are placed therein depending on the type of litter bag 20 being used. For example, bag ties 745 may be more convenient for closing plastic bags while tape 749 may be more convenient for closing paper bags.

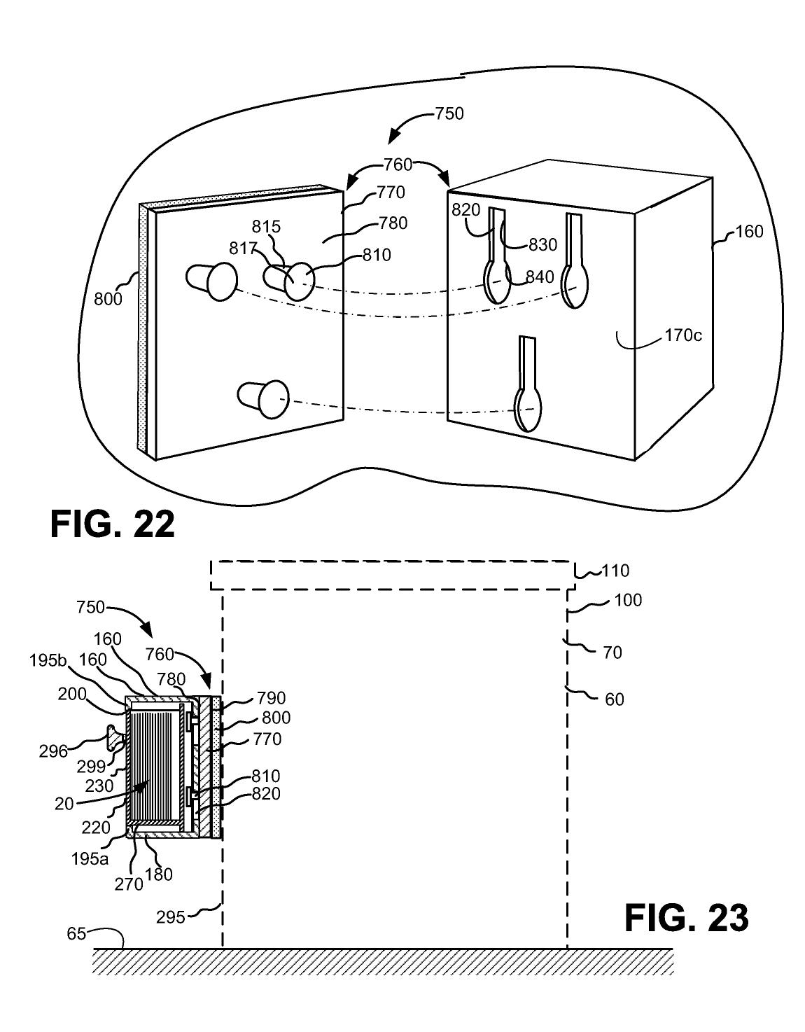

FIGS. 22 and 23 illustrate a tenth embodiment litter bag holder, generally referred to as 750. Tenth embodiment litter bag holder 750 comprises a seventh embodiment attachment arrangement, generally referred to as 760, for coupling housing 160 to support structure 295. Seventh embodiment attachment arrangement 760 comprises a mounting bracket 770 having a front surface 780 and a rear surface 790. Rear surface 790 is adapted to accommodate an adhesive layer 800. The adhesive layer 800 may be an epoxy adhesive for allowing seventh embodiment attachment arrangement 760 to be easily peeled away from support structure 295, which may be desirable if a worn or damaged seventh embodiment litter bag holder 750 needs replacement. Alternatively, adhesive layer 800 may be an acrylic adhesive for allowing permanent attachment of mounting bracket 770 to support structure 295. In either case of a peel-away adhesive layer or a permanent adhesive layer, use of mounting bracket 770 obviates the need for double-sided adhesive tape, hook-and-loop fasteners, and screw fasteners and therefore obtains a less complex construction requiring fewer components. Obtaining a less complex construction requiring fewer components encourages the user to utilize litter bags 20 and may reduce manufacturing costs for tenth embodiment litter bag holder 750.

Referring again to FIGS. 22 and 23, outwardly projecting from front surface 780 and integrally attached thereto is at least one stud 810 having a shaft portion 815 integrally connected to a bulbous end portion 817 for engaging a corresponding slot 820 defined by rear sidewall 170c of housing 160. Slot 820 is sized to engage stud 810. Preferably, slot 820 is shaped such that slot 820 has a rectangularly-shaped keyway portion 830 in communication with a circular-shaped hole 840. In use, hole 840 is aligned with bulbous end portion 817 so that bulbous end portion 817 engages hole 840. Housing 160 is then moved downwardly so that shaft portion 815 slidably engages keyway portion 830. In this manner, housing 160 is releasably secured to mounting bracket 770, and thus releasably secured to support structure 295. Housing 160 is released from mounting bracket 770 by reversing the procedure described immediately hereinabove.

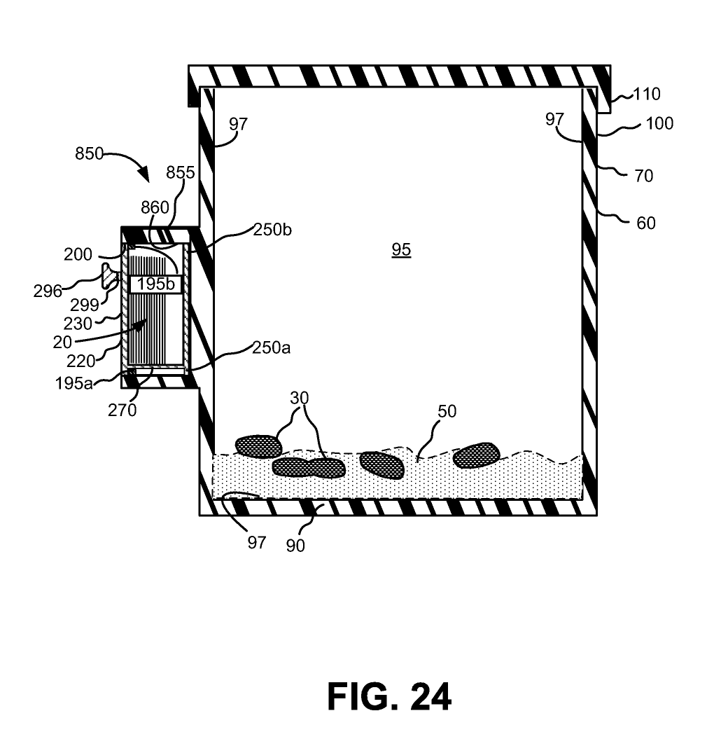

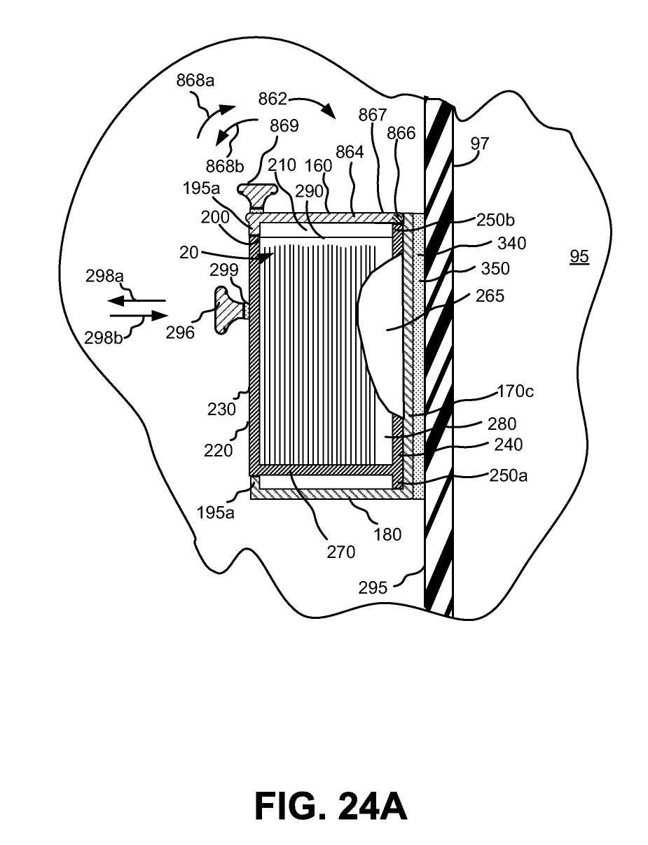

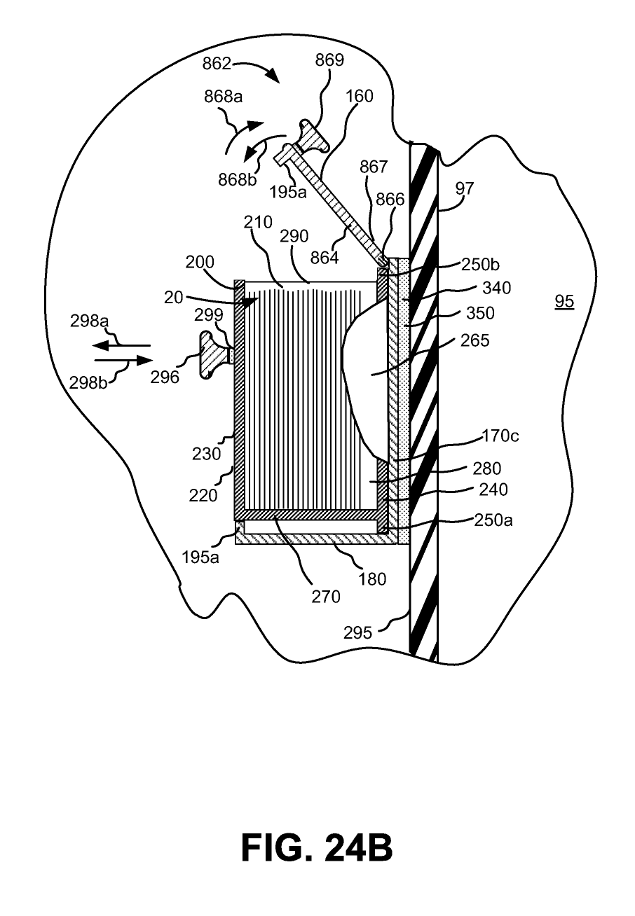

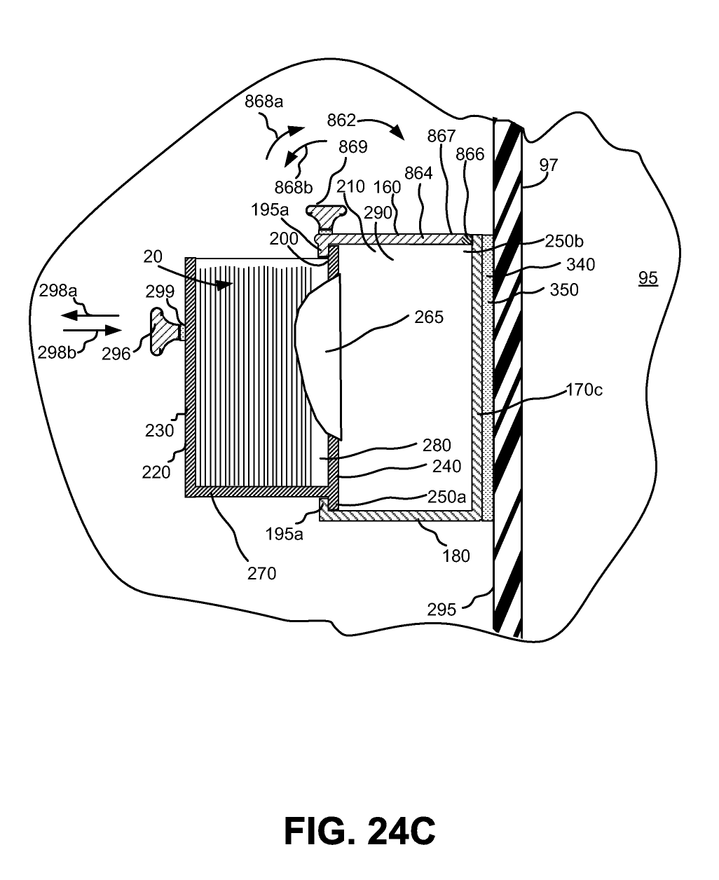

Turning now to FIG. 24, an eleventh embodiment litter bag holder, generally referred to as 850, is there shown. Eleventh embodiment litter bag holder 850 is integrally formed with base portion 70 of cat litter box 60, such as being integrally formed with side panel 80a of cat litter box 60, so that integrally formed housing 855 and cat litter box 60 form a single unit. Thus, integrally formed housing 855 is necessarily made of the same material as base portion 70 of cat litter box 60. Integrally formed housing 855 defines a chamber 860 therein for receiving previously mentioned first configuration drawer 220 (see, e.g., FIG. 4). As shown in FIG. 24, this configuration of integrally formed housing 855 and base portion 70 of cat litter box 60 allows base portion 70 and integrally formed housing 855 to be cast from a mold as a single unit, thereby eliminating need for adhesives, hook-and-loop fasteners, and screws in order to couple the housing to support structure 295. Eliminating need for adhesives, hook-and-loop fasteners, and screws may reduce manufacturing costs associated with cat litter box 60 and the accompanying litter bag holder.

Referring to FIGS. 24A, 24B and 24C, there is shown a twelfth embodiment litter bag holder, generally referred to as 862. Twelfth embodiment litter bag holder 862 is substantially similar to second embodiment litter bag holder 330, except stationary top wall 190 is replaced by a pivotable top wall 864 capable of pivoting about an elongate, horizontal pivot pin 866. Pivot pin 866 extends from right sidewall 170b, through an end portion 867 of top wall 864 and to left sidewall 170a. Top wall 864 can be pivoted upwardly to an open position along directional arrow 868a to access litter bags 20 and pivoted downwardly to a closed position along directional arrow 868b to cover litter bags 20. In addition, a top wall knob 869 is connected to top wall 864 for pivoting top wall 864 about pivot pin 866. Thus, it should be appreciated that this embodiment of the invention allows two convenient alternative means for accessing litter bags 20. The first convenient means for accessing litter bags 20 is to outwardly translate drawer 220 from housing 160 along previously mentioned directional arrow 298a by pulling knob 296. After the user retrieves litter bag 20, drawer 220 is then inwardly translated into housing 160 along previously mentioned directional arrow 298b by pushing knob 286. The second convenient means for accessing litter bags 20 is to upwardly rotate top wall 864 about pivot pin 866 in the direction of directional arrow 868a by upwardly pulling top wall knob 869. After the user retrieves litter bag 20, the user downwardly rotates top wall 864 about pivot pin 866 in the direction of directional arrow 868b by downwardly pushing top wall knob 869. According to this second convenient means for accessing litter bags 20, top wall 864 may be considered as having a “flip top” configuration. Having these two alternative and convenient means for accessing litter bags 20 encourages the user to utilize litter bags 20.

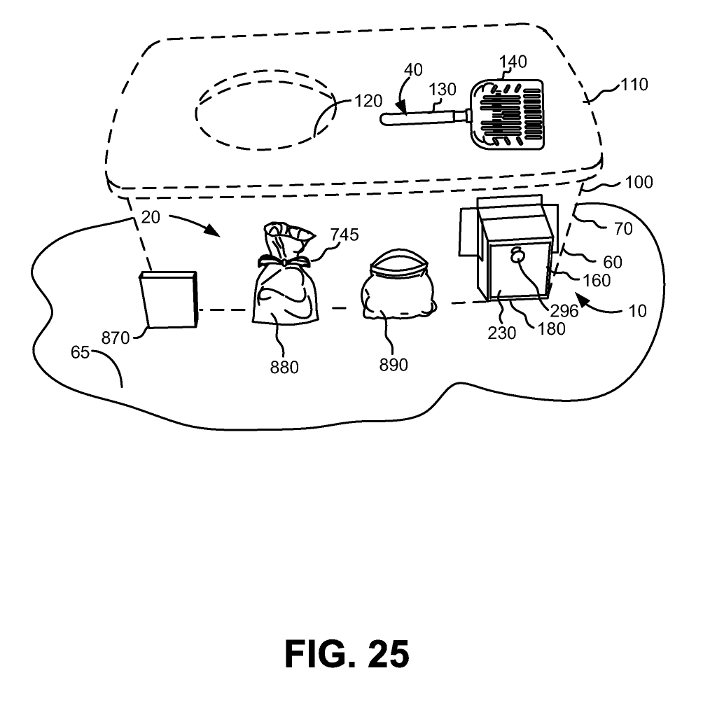

As best seen in FIG. 25, exemplary types of litter bags 20 are displayed that are receivable in any of the previously mentioned embodiments of the litter bag holder. First embodiment litter bag holder 10 is shown in association with the exemplary types of litter bags 20 for purpose of illustration only and not for purpose of limitation. By way of example only, and not by way of limitation, any of litter bags 20 may be a paper litter bag 870 closable by being folded, stapled or taped; a plastic or cloth litter bag 880 closable preferably by means of previously mentioned bag tie 745; or a plastic litter bag 890 closable by means of a press-fit. Such a plastic litter bag 890 that is closable by means of a press-fit may be of a type that is a commercially available plastic bag marketed under the mark “ZIPLOC®” by S.C. Johnson & Son, Incorporated located in Racine, Wis. U.S.A.

### Illustrative Methods:

An illustrative method associated with an exemplary embodiment for manufacturing the litter bag holder according to the invention will now be described.

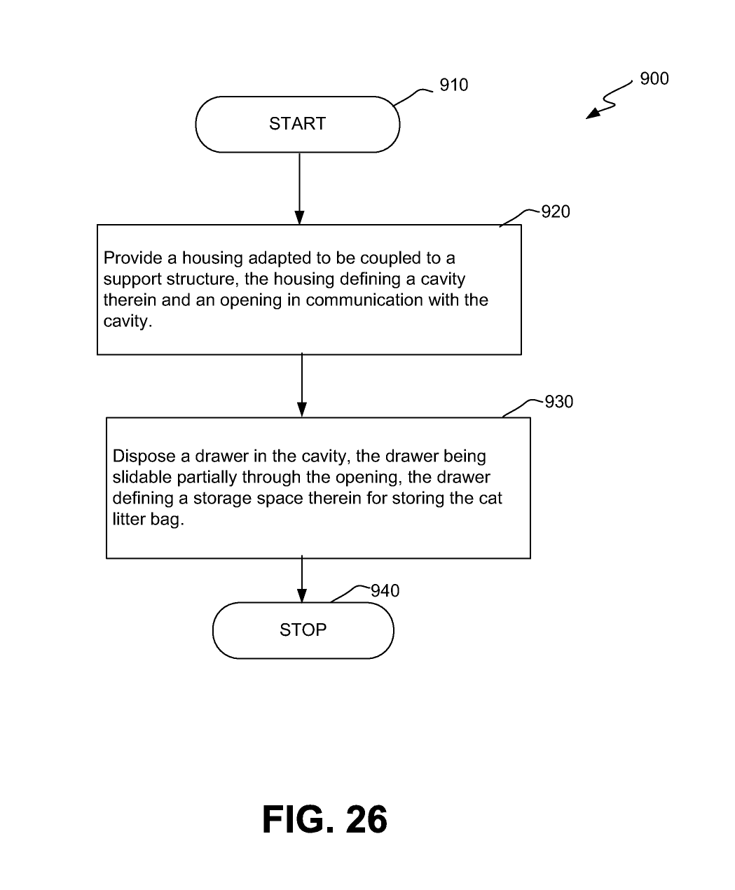

Referring to FIG. 26, an illustrative method, generally referred to as 900, is provided for manufacturing a bag holder for holding a cat litter bag adapted to contain cat litter waste retrieved from a cat litter box. The method starts at a step 910. At a step 920, a housing adapted to be coupled to a support structure is provided, the housing defining a cavity therein and an opening in communication with the cavity. At a step 930, a drawer is disposed in the cavity, the drawer being slidable partially through the opening, the drawer defining a storage space therein for storing the cat litter bag. The method stops at a step 940.

Other modifications and implementations will occur to those skilled in the art without departing from the spirit and the scope of the invention as claimed. For example, housings 160/855 and drawers 220/560/600/670 may be made of a transparent material, such as a transparent polymer, for conveniently viewing storage space 280 to visually ascertain whether storage space 280 needs to be refilled with litter bags 20. As another example, housings 160/855 and drawers 220/560/600/670 contained therein may be oriented horizontally rather than vertically. As a further example, cat litter bags 20 may be stacked horizontally rather than vertically within drawers 220/560/600/670, if desired. Accordingly, the description hereinabove is not intended to limit the invention, except as indicated in the following claims.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims. The patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicant(s).

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A bag holder for holding a plurality of cat litter bags adapted to contain cat litter waste from a cat litter box, the bag holder comprising:
a housing adapted to be coupled to a support structure, the housing defining a cavity therein, and defining an opening in communication with the cavity; and
a drawer adapted to be disposed in the cavity, the drawer being slidable partially through the opening, the drawer defining a storage space therein for storing the plurality of cat litter bags.

2. The bag holder of claim 1, further comprising an attachment arrangement adapted to couple the housing to the support structure.

3. The bag holder of claim 2, wherein the attachment arrangement includes at least one of: a brace and a screw fastener.

4. The bag holder of claim 2, wherein the attachment arrangement includes at least one of: an adhesive layer and adhesive tape.

5. The bag holder of claim 2, wherein the attachment arrangement includes hook-and-loop fastener material.

6. The bag holder of claim 2, wherein the attachment arrangement comprises:
a mounting bracket; and
at least one stud attached to the mounting bracket, and
wherein housing defines at least one slot therein sized to slidably engage the at least one stud for slidably coupling the housing to the mounting bracket.

7. The bag holder of claim 2, wherein the attachment arrangement comprises:
a mounting plate; and
a bag closure dispenser coupled to the mounting plate for dispensing a bag closure therefrom.

8. The bag holder of claim 1, wherein the support structure is a side panel of the cat litter box, and wherein the housing is integrally formed with the side panel so as to define a cavity having an opening.

9. The bag holder of claim 1, wherein the drawer comprises:
a bag support disposed in the storage space and adapted to support cat litter bags; and
a biasing member coupled to the bag support for biasing the bag support.

10. The bag holder of claim 1, wherein the drawer includes opposing side walls, each side wall defining a plurality of expandable flutes therein for expandably moving the drawer through the opening.

11. The bag holder of claim 1, wherein the drawer comprises:
a pivot pin connected to the housing; and
opposing side walls rotatably mounted on the pivot pin, the side walls defining a plurality of expandable and bendable flutes therein for expanding and bending the drawer about the pivot pin in a downward arc through the opening.

12. The bag holder of claim 1, wherein at least one of the drawer and the housing includes a pathogen resistant, anti-microbial, antifungal composition for decreasing health risk to humans.

13. The bag holder of claim 1, wherein the drawer includes a pivotable top wall coupled to the housing.

14. A bag holder for holding cat litter bags adapted to contain cat litter waste from a cat litter box, the bag holder comprising:
a housing that is integrally formed with a side panel of the cat litter box so as to define a cavity having an opening; and
a drawer disposed within the cavity, and slidable partially through the opening, the drawer defining a storage space therein for storing the cat litter bags.

15. The bag holder of claim 14, wherein the drawer comprises:
an upright bag support slidably disposed within the storage space, and adapted to support and compress the cat litter bags; and
a spring attached to the bag support for biasing the bag support, whereby the cat litter bags are supported and compressed in the storage space as the bag support is biased.

16. The bag holder of claim 14, wherein the drawer includes opposing side walls, each side wall defining a plurality of expandable flutes therein for expandably moving the drawer through the opening.

17. The bag holder of claim 14, wherein the drawer comprises:
a pivot pin connected to the housing; and
opposing side walls rotatably mounted on the pivot pin, the side walls defining a plurality of expandable and bendable flutes therein for expanding and bending the drawer about the pivot pin in a downward arc through the opening.

18. The bag holder of claim 14, wherein at least one of the drawer and the housing comprises a pathogen resistant, anti-microbial, antifungal composition for decreasing health risk to humans.

19. The bag holder of claim 14, wherein the drawer comprises a top wall adapted to pivot about a pivot pin coupled to the housing.

20. A method of manufacturing a bag holder for holding cat litter bags adapted to contain cat litter waste retrieved from a cat litter box, the method comprising:
providing a housing adapted to be coupled to a support structure, the housing defining a cavity therein and an opening in communication with the cavity; and
disposing a drawer in the cavity, the drawer being slidable partially through the opening, the drawer defining a storage space therein for storing the cat litter bags.
